(19) United States
(12) Patent Application Publication
(10) Pub. No.: US 2022/0323287 A1
(43) Pub. Date: Oct. 13, 2022

(54) DEVICE FOR DRY MASSAGE BY MEANS OF WATER JETS

(71) Applicant: JK-HOLDING GMBH, Windhagen (DE)

(72) Inventor: Jürgen GERSTENMEIER, Windhagen (DE)

(21) Appl. No.: 17/283,778

(22) PCT Filed: Oct. 11, 2019
(86) PCT No.: PCT/DE2019/100882

§ 371 Date: Jun. 29, 2022

(30) Foreign Application Priority Data
Oct. 11, 2018 (DE) 10 2018 125 146.7

(51) Int. Cl. A61H 9/00

(52) U.S. Cl. CPC A61H 9/0021; A61H 2201/0142; A61H 2201/1215; A61H 2201/149; A61H 2201/1623; A61H 2201/1654; A61H 2201/1666; A61H 2201/1669; A61H 2203/0456; A61H 2205/062; A61H 2201/1645; A61H 2205/081; A61H 2201/1614

(57) ABSTRACT

The invention relates to a device (V) for dry water-jet massage, comprising: a tub (W), which is filled with massage water and runs from a head end to a foot end in the longitudinal direction and from a left side to a right side in the transverse direction, having a film material (F) as a cover closing the tub (W) water-tight on the top side, which film material is simultaneously used as a lying surface for a person (Pe) to be treated and allows the transmission of pressure pulses; a nozzle cart (1), which can be moved in the longitudinal direction of the tub (W) and bears at least two nozzles (D, D′, D″), which nozzles (D, D′, D″) can be fed with massage water from the tub (W) by means of a pump (P) in order to eject one water jet per nozzle against the bottom side of the film material (F); a first drive (3) for the forward and backward movement of the nozzle cart (1) in the longitudinal direction of the tub (W), the at least two nozzles (D, D′) moving forward and backward in the longitudinal direction of the tub (W) with the movement of the nozzle cart (1); and a second drive (5, ZR, Z), which moves the nozzles (D, D′) in the transverse direction of the tub (W). A device by means of which regions of the body of the person that are at a distance from the plane of the film can also be treated is achieved in that the film material (F) has one or more cavities on the bottom side of the film, which run in the transverse direction, are directed at the person (PE) lying on the film material (M) and shape the film (F) into one or more elevated portions (100), which are convex on the top side of the film.

The present invention relates to a device for dry massage by means of water jets. In particular, the present invention relates to a device for dry massage with water jets, with which the body of a user or patient can be massaged in a variety of ways with a plurality of massage step sequences by means of water jets without having to accept wetting of the body.

A water-jet massage is a long-established type of massage in which the body of a user is exposed to the massaging treatment of a water jet. Specific parts of a person's body reached by the water jet are touched by the mechanical impact of the water jet under a specific pressure. The recurring and/or prolonged application of pressure to specific parts of the person's body results in a pleasant, relaxing and, in many cases, healing massage of specific parts of the body or the whole body of the person being treated. Such massages, in particular as so-called “underwater massages” have long been an integral part of the treatment plan of many persons in need of massage treatment.

In the meantime, devices for dry water-jet massage have also become known in the prior art. In the present description and in the claims—as well as in the prior art—“dry water-jet massage” is understood to mean that the body of a user of a corresponding device or the body of a person in need of a massage, e.g. a patient, is lying on a pressure pulse transmitting material, for example on a plastics material film or a rubber film of a device. Underneath this material, the device has an attached means for emitting a movable jet pulse which is subjected to adjustable pressure, for example one or more nozzle(s) ejecting in each case one water jet, with the jet direction directed to the bottom side of the film material transmitting pressure pulses. The means mentioned consists of a nozzle cart having a lower part, on which a top part with one or more nozzles is attached, which can be moved via a toothed belt drive along the longitudinal axis of the device and “drives” on the tub bottom on rollers on a—often double-track—rail. This/These nozzle(s) is/are attached pivotably in the transverse direction to the direction of movement of the nozzle cart. The water jet(s) ejected from the nozzle(s) transmit(s) the pulse to the plastics material or rubber film material, e.g. the lying surface made of natural rubber, and this/these transmit(s) the pulse to the body parts of the user/patient lying on the material. The pulse has the desired massaging effect on the parts of the body that are in contact with the film material transmitting a pulse, and thus simulates a massage treatment that is similar to an underwater massage. This also applies to the transfer of heat from the massage medium (water) to the body of a user/patient lying on the film material. With such a massage treatment, the user of the device or the person to be treated remains dry. Massage programs specified or compiled by a masseur or therapist can be transferred to the control of the device via a chip card. Such devices are commercially available, for example, under the name “HYDROJET” from Wellsystem GmbH. They allow a water-jet massage both in an environment in which devices for a proper underwater massage are not available or the necessary wet rooms cannot be set up, as well as for persons/patients who cannot be treated underwater for hygienic or health reasons, for example because of wounds that have not yet healed.

KR 10 2011 129 315 A describes a device designed as a massage chair for dry water-jet massage, in which the region of a backrest is covered with a flat film, and in particular the region of the seat is provided with a container for water. A nozzle cart, which carries two nozzles, is moved in a plane along a guide via a belt drive and a motor provided in the backrest. The nozzles for ejecting massage water can be moved individually via a belt drive with a motor and a belt in a direction perpendicular to the direction of displacement of the nozzle cart. Furthermore, the nozzles can be pivoted by a separate drive and an associated gear mechanism about a pivot axis aligned parallel to the direction of displacement of the nozzle cart. One disadvantage of the known device is that only the back can be massaged. Furthermore, the parts of the body that do not lie directly on the film are not reached by the massage nozzle.

U.S. Pat. No. 2,009,031 26 80 A1 describes a device for dry water-jet massage, which is designed either as a bed or as a massage chair, in which a tub filled with massage water with a film material as a cover closing the tub water-tight on the top side, which film material is simultaneously used as a lying surface for a person to be treated and allows the transmission of pressure pulses. In this case, a nozzle cart is provided, which can be moved along rails arranged above the base of the tub by means of a carriage with wheels connected to the end of the nozzle cart, in which the nozzle cart can be displaced in the longitudinal direction within the tub via a spindle nut connected thereto and a spindle screw extending through the tub in the longitudinal direction between the rails, which spindle screw is driven by a motor. In this case, the nozzle cart has a hollow outer plate body on which a plurality of nozzles are provided, which can be fed with massage water from the tub by means of a pump via a flexible hose connection, in order to eject a water jet against the bottom side of the film material, and which are supplied with massage water from the tub via a flexible hose connection. In this case, the movement of the nozzles forward and backward in the longitudinal direction of the tub takes place with the movement of the nozzle cart, while movement in the transverse direction is not provided. Underneath the film, at locations where the water jet is to be concentrated, drainage devices are provided above the nozzles in the manner of drainage plates, which either concentrate the ejected water centrally on the film in the region of the head/neck or distribute it in the region of the foot, for example, such that two mountains are generated in the film.

The document EP 1 666 017 A1 describes a device for dry water-jet massage with a tub that is covered by a film serving as a support surface for the patient, and with a nozzle cart mechanism arranged inside the tub for generating at least one massage water jet directed against the bottom side of the film. The nozzle cart mechanism has at least one guide rail that can be rotated about a longitudinal axis of rotation within the tub by motor, and the nozzle cart mechanism has a nozzle cart or a nozzle carriage on the rotatable guide rail that can be moved by motor along the guide rail and that supports at least one nozzle fed by a pump for the generation of a massage water jet. When the guide rail, which can be rotated by motor about the longitudinal axis of rotation, is pivoted, the nozzle cart or nozzle carriage running parallel to the axis of rotation on the guide rail also pivots, so that the nozzle located on its top side can change the direction of the water jet exiting under pressure at a right angle relative to the axis of rotation. Together with the path of the nozzle cart running along the axis, the massage water jet can be directed in flat patterns that hit the bottom side of the liner film, whose course in the longitudinal direction of the tub is determined by the run of the nozzle cart on the guide rail and whose course in the transverse direction of the tub is determined by the pivoting of the guide rail and the nozzle cart pivoting with the guide rail, the nozzle cart having the nozzle arranged thereon.

As a further prior art, the document EP 2 327 386 A1 describes a tub-shaped device for dry massage by means of water jets of the type already mentioned at the outset, i.e. the type having a nozzle cart which is driven by a motor, that can be operated outside the tub, and which is movable on a roller on rails fixed in the longitudinal direction on the tub bottom under a liner film that covers and seals the tub. The nozzle cart carries at least two nozzles, which is pivotable in the transverse direction to the rails in order to eject a water jet against the bottom side of the liner film. The independent control of the two pivotable nozzles takes place by means of a spline shaft which is rotatably mounted about its own axis in the longitudinal direction of the tub and which runs load-free through a sliding bush in the nozzle cart. The back-and-forth movement of each spline shaft, which can be controlled as required by a motor (also electronically via a program), is ultimately transmitted to the bearing of one of the at least two pivotable nozzles via kinematics arranged on the nozzle cart with positive force transmission, so that these kinematics—depending on the range of the rotary movement of the associated spline shaft—deflect the respective water jet more or less strongly across the direction of travel of the nozzle cart, whereby the desired water-jet massage pattern can be created on the bottom side of the liner film.

The disadvantage of the devices known from the prior art for dry water-jet massage is that—without exception—all devices are limited to a massage effect only on the locations of the body of the person in need of a massage, e.g. of a patient, which are in direct contact with the liner film when the patient has sat down for the massage on the liner film. This is unsatisfactory insofar as parts of the body such as the upper shoulder muscles, the side regions of the neck, the inside and outside of the arms and legs are locations in many people where pain and ailments occur, which can be resolved with a massage—and also with a dry massage with water jets. However, these locations cannot be brought into contact with the liner film. Therefore, they cannot be massaged with a dry massage using water jets with the previously known devices.

The object of the invention is to remedy this disadvantage. The invention surprisingly provides a device for dry massage by means of water jets which can also massage the body in locations that were previously inaccessible to dry massage by means of water jets. The shoulders or the soles of the feet are mentioned as examples.

According to an aspect of the invention, a device for dry water-jet massage is created, comprising a tub, which is filled with massage water and runs from a head end to a foot end in the longitudinal direction and from a left side to a right side in the transverse direction, having a film material as a cover closing the tub water-tight on the top side, which film material is simultaneously used as a lying surface for a person to be treated and allows the transmission of pressure pulses; a nozzle cart, which can be moved in the longitudinal direction of the tub and bears at least two nozzles, which nozzles can be fed with massage water from the tub via a flexible hose connection by means of a pump in order to eject one water jet per nozzle against the bottom side of the film material; a first drive for forward and backward movement of the nozzle cart in the longitudinal direction of the tub, the at least two nozzles moving forward and backward in the longitudinal direction of the tub with the movement of the nozzle cart; and a second drive, which moves the nozzles in the transverse direction of the tub, and which is distinguished in that the film material has one or more cavity/cavities on the bottom side of the film, which run in the transverse direction, being directed at the person lying on the film material, and shaping the film into one or more elevated portions, which are convex on the top side of the film.

A favorable further development results from the fact that means for displacing or pivoting the nozzles out of the plane of the tub are provided, which allow directing the ejected water jet against the cavity/cavities on the bottom side of the film and in particular against a surface inclined relative to the plane of the film of the cavity/cavities on the bottom side of the film. In particular, these means allow the nozzle holders carrying the nozzles to be pivoted about an axis perpendicular to the direction of displacement of the nozzle cart, whereby the water jet ejected by the nozzle is given a component of the orientation counter to or in the direction of displacement of the nozzle cart, so that in particular the region of a cavity on the bottom side of the film, which protrudes almost perpendicularly from the film, can be easily reached, and in particular can be treated with the water jet at a relatively small angle to the normal. As a result, the shoulders of a patient, in particular, but also other parts of the body resting on the elevated portions, can be effectively acted upon by the massage nozzle.

It is preferably further provided that a part of the nozzle cart carrying the nozzles is pivotable relative to the nozzle cart about an axis in the direction of the film, and that the ejected water jet assumes an angle to the normal of the film by pivoting.

The pivoting movement of the part carrying the nozzles is expediently achieved by a ramp arranged in the tub, wherein the forward and backward movement generated by the first drive displaces the part with respect to the ramp and thus pivots upward about a horizontal axis that is preferably perpendicular to the direction of displacement of the nozzle cart.

In this case, in a favorable embodiment, the nozzle is held eccentrically to the pivot axis by means of the nozzle holder forming a link, so that the pivoting not only advantageously causes a change in the angle of the water jet, but at the same time also a displacement with a component in the z direction which is perpendicular to the direction of displacement of the nozzle cart and is perpendicular to the direction of displacement of the nozzle holder perpendicular thereto. As a result, the distance between the nozzle and the film can advantageously be changed without the nozzle cart itself having to leave its plane of travel, so that its drive can be designed in a simple manner.

Each of the nozzles is expediently arranged in its own nozzle holder, which can be independently pivoted upward with respect to the travel path of the nozzle cart. Preferably, all nozzle holders are pivoted together, for example by being coupled to a part of the nozzle cart that is deflected by the ramp or ramps. The coupling is expediently carried out via a rigid axis which pivotably passes through all nozzle holders.

According to a favorable embodiment, it is provided that the nozzle holder is connected to a toothed rack which, as part of the second drive, allows the individual displacement of the nozzle holder in the transverse direction of the tub by means of a gear of the drive. The toothed rack is expediently connected to a cage which is axially displaceable along a first axis and which carries the nozzle holders along in the direction of this axis, for example by engaging around the nozzle holders on both sides. As a result, the displacement of the cages with the toothed rack in the transverse direction, i.e. perpendicular to the direction of displacement of the nozzle cart, is transferred to the nozzle holders, regardless of the angle that the nozzle holder assumes about its pivot axis. As a result, the toothed rack is advantageously coupled to the associated second drive at all times, even if a ramp is traveled over, so that an adjustment or movement of the nozzle in the transverse direction is ensured even while the nozzle holders are pivoted.

The nozzle holder is therefore preferably also pivotable with respect to the toothed rack, in which in a favorable variant the toothed rack is movably connected to two axes of the nozzle cart, one of which is preferably also the axis about which can pivot the nozzle holder.

This advantageously means that the nozzle holder is connected to a rigid axis of the nozzle cart so that it can both be axially displaced and pivoted.

An aspect of the invention relates to a device for dry water-jet massage that comprises:

(a) a tub, which is filled with massage water and runs from a head end to a foot end in the longitudinal direction and from a left side to a right side in the transverse direction, having a film material as a cover closing the tub water-tight on the top side, which film material is simultaneously used as a lying surface for a person to be treated and allows the transmission of pressure pulses;
(b) wherein the film material has one or more cavity/cavities on the bottom side of the film, which run in the transverse direction, being directed at the person lying on the film material, and shaping the film into one or more elevated portions, which are convex on the top side of the film;
(c) a nozzle cart movable on wheels on two rails fixed on the bottom of the tub in the longitudinal direction of the tub, carrying at least two nozzles, with a drive that acts on the bottom side of the nozzle cart and is mounted inside the tub and can be operated from outside the tub by means of a motor for forward and backward movement of the nozzle cart in the longitudinal direction of the tub;
(d) wherein the nozzle cart comprises, parallel to the tub bottom, a horizontal bottom plate which can be moved in the longitudinal direction of the tub on the wheels and has a vertical side plate fixed to the bottom plate in each case on the left and on the right, wherein a first pivot axis running in the transverse direction of the tub and optionally a second pivot axis running in the transverse direction of the tub and being offset from the first pivot axis and being able to serve for guiding purposes rigidly connects the vertical side plates together,
(e) wherein, on each of the outer sides of the side plates, a tilting plate is attached pivotably to the first pivot axis that runs in the transverse direction of the tub and a rigid axis that runs in the transverse direction of the tub connects the tilting plates to one another, wherein each of the tilting plates has an rolling wheel on the outside (in the transverse direction) at the end of the tilting plate lying opposite the tilting plate stop in each case with one wheel axis parallel to the first and second pivot axes;
(f) and wherein the nozzle cart has at least two nozzles that can be moved on the nozzle cart and can be fed with massage water from the tub by means of a pump via a flexible hose connection, in order to eject a water jet against the bottom side of the film material,
(g) wherein the movement of the at least two nozzles forward and backward in the longitudinal direction of the tub takes place with the movement of the nozzle cart; the concentric movement of the at least two nozzles—running in the transverse direction of the tub by means of two running parallel to the longitudinal axis of the device in each case through a bushing on the bottom side of the nozzle cart and being in engagement with a gear with a wheel axis arranged on the bottom side of the nozzle cart bottom—can be effected in each case with one of the spline shafts, and the spline shafts are mounted on the head side in a bearing lying inside the tub so as to be rotatable about their own axis and are controlled on the foot side by a drive motor lying outside the tub to perform a rotating back-and-forth movement around each spline shaft longitudinal axis, wherein the gears that are each engaged with a spline shaft are in turn engaged with toothed racks that are arranged parallel to the pivot axes on the lower nozzle holders and cause a nozzle movement in the transverse direction of the tub along the pivot axes, without the spline shaft having load-bearing function, in particular nozzle cart-bearing function;
(h) wherein at least one of the nozzles is able to direct its ejected water jet on the bottom side of the film material onto the interior of the one or more cavities on the bottom side of the film which shape convex elevated portions on the top side of the film material.

Preferred embodiments of the device according to the invention are claimed in the dependent claims.

An aspect of the invention also relates to a dry water-jet massage method, in which the body of a person to be treated—which is arranged on a film material which allows a transmission of pressure pulse and which is designed as a top cover of a device according to the following detailed description—is exposed to a water jet pressure pulse ejected through at least one nozzle onto the bottom side of the film material and optionally into the interior of at least one of the one or more transversely extending cavity/cavities on the bottom side of the film directed at the person lying on the film material and shaping the film to one or more convex elevated portion(s) on the top side of the film with translational movement of at least one of the nozzles delivering the pulse for a specific time in the longitudinal direction and transverse direction of the tub, which has a massage effect on the body of the person to be treated or the person in need of a massage.

In particular, the device of the invention allows or facilitates a massage of a person to be treated or a person in need of a massage by the “dry water jets” on himself, so that under specific conditions the masseur is dispensable or can dedicate himself in parallel to the massage of a plurality of persons by the device according to the invention.

Finally, an aspect of the invention also relates to the use of the device according to the following detailed description for body massage, preferably for massage for releasing cramps and tenseness, for relaxation, for eliminating muscular imbalances, for eliminating stress-related muscular tension, for relieving pain, in particular in sports injuries and/or for the treatment of cervical migraines and for other indications.

According to an aspect of the invention, a method for operating a device for dry water-jet massage is created as described above, with the step of directing the water jet ejected by a nozzle against the film material and/or one of the cavity/cavities on the bottom side of the film with simultaneous pivoting of a nozzle holder carrying the nozzle about an axis running perpendicular to the direction of displacement of the nozzle cart, whereby the distance between the nozzle and the film is reduced and/or the parts of the cavity/cavities on the bottom side of the film are targeted with the water jet. As a result, it is in particular not necessary to provide baffles in the tub, which dampen the water jet and extremely restrict the use of the device.

According to a favorable feature, it is provided that the nozzle is raised or pivoted into the cavity in order to apply the water jet to the inner circumferential wall of the cavity. This gives the special feature that the nozzle is used above the actual level of the film or the lying surface, so that a very well placed massage is possible.

Preferably the angle of incidence of the water jet ejected onto the bottom side of the film is reduced from a value of 90°, i.e. perpendicular to the bottom side of the film, to acute angles, preferably reduced to a value of the angle of incidence of <10°, for example about 6°. Correspondingly, the pivoting angle that a nozzle holder covers is almost 90°.

Further advantages, properties and developments of the invention emerge from the following description of a preferred embodiment and from the dependent claims.

The invention is described below with reference to figures which only describe preferred embodiments of the device according to the invention. However, neither the figures referred to below nor the following description are to be understood as limiting the invention to the preferred embodiments shown or described.

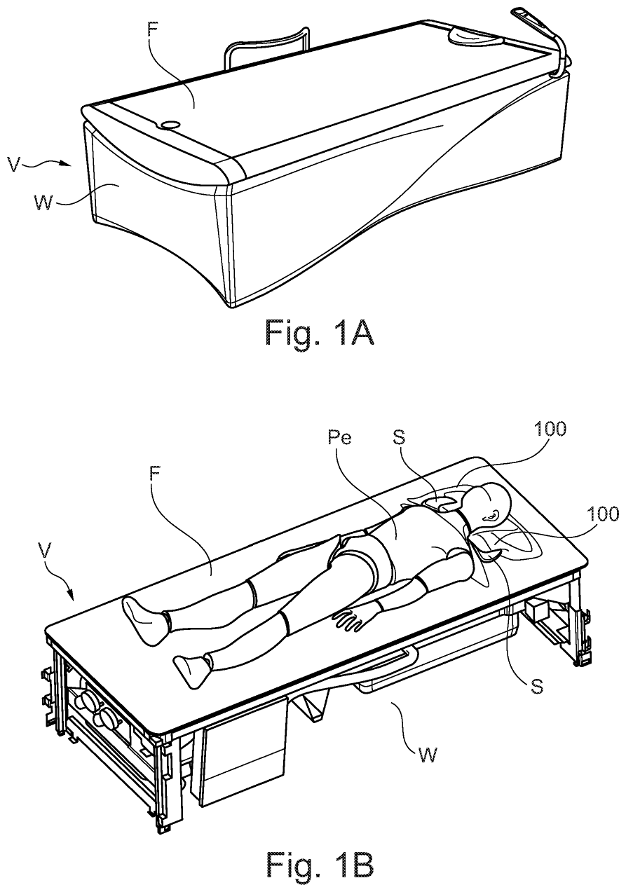

FIG. 1A shows a water-jet massage device according to the prior art.

FIG. 1B shows a water-jet massage device according to an embodiment of the present invention.

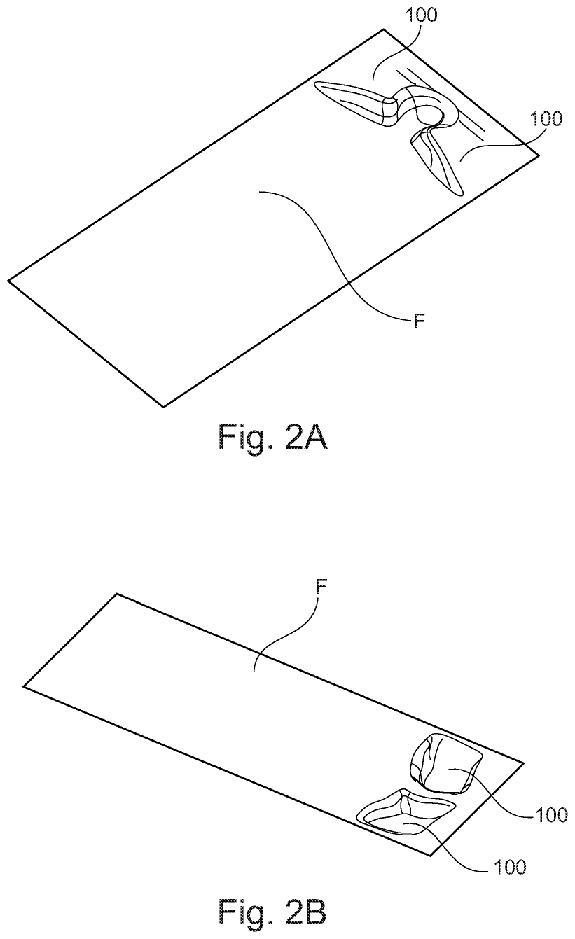

FIG. 2A is a top perspective view of the film material tub cover W.

FIG. 2B is a bottom perspective view of the film material tub cover.

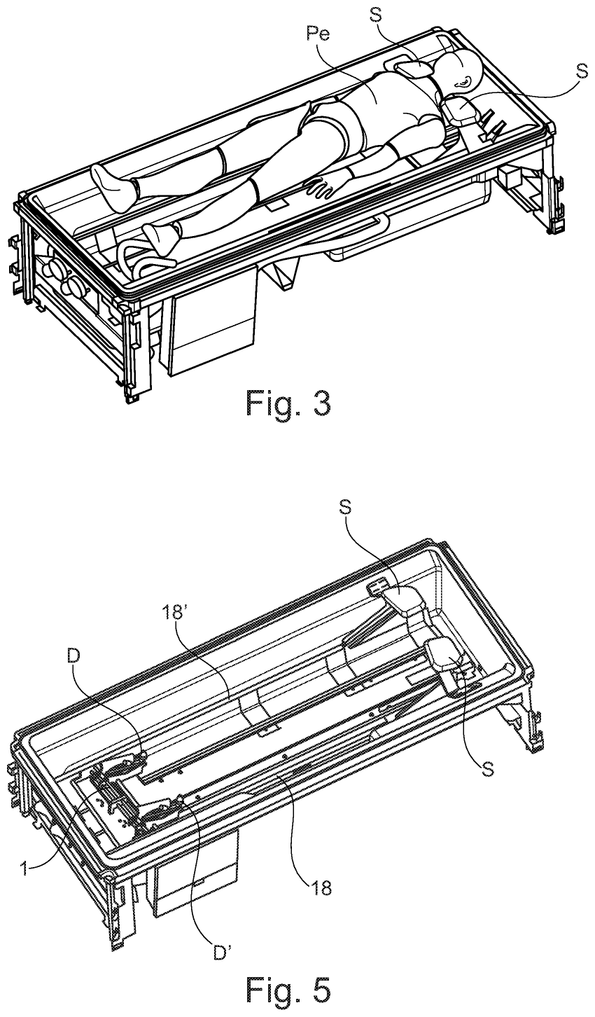

FIG. 3 shows an embodiment of a water-jet massage device according to the invention, similar to FIG. 1B, but without the top film cover; also shown, for example, on the left and right of the head of the person Pe to be massaged, is a support surface S for the film cover.

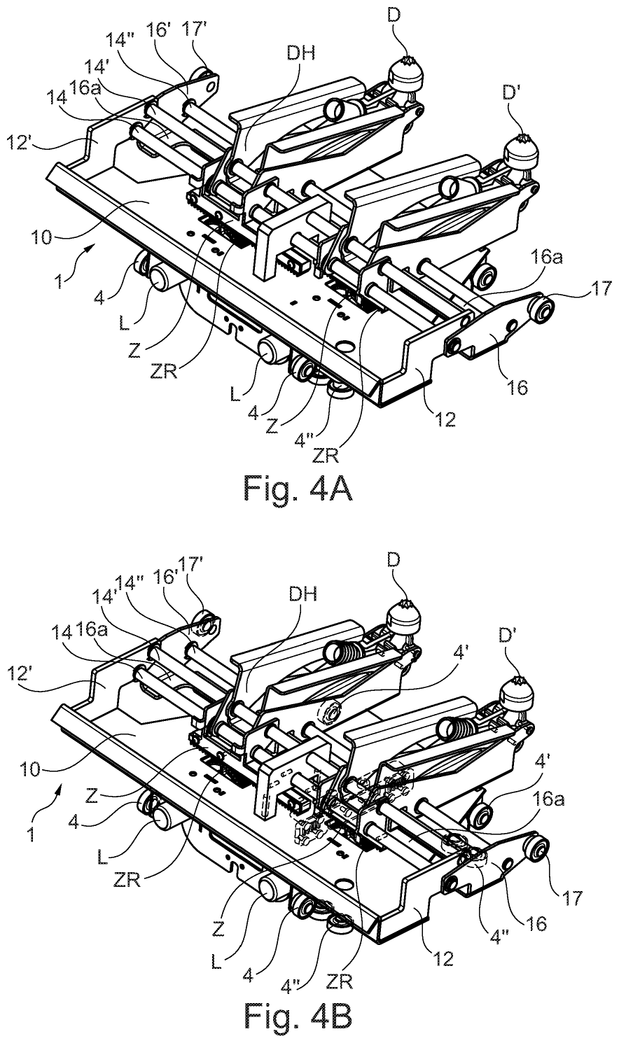

FIGS. 4A and 4B show the nozzle cart of the water-jet massage device according to the invention.

FIG. 5 shows an embodiment of the water-jet massage device according to the invention without a covering liner film with the nozzle cart 1 carrying the nozzles D, D′ and bringing them into position in order to eject massage water in the starting position at the foot end of the tub.

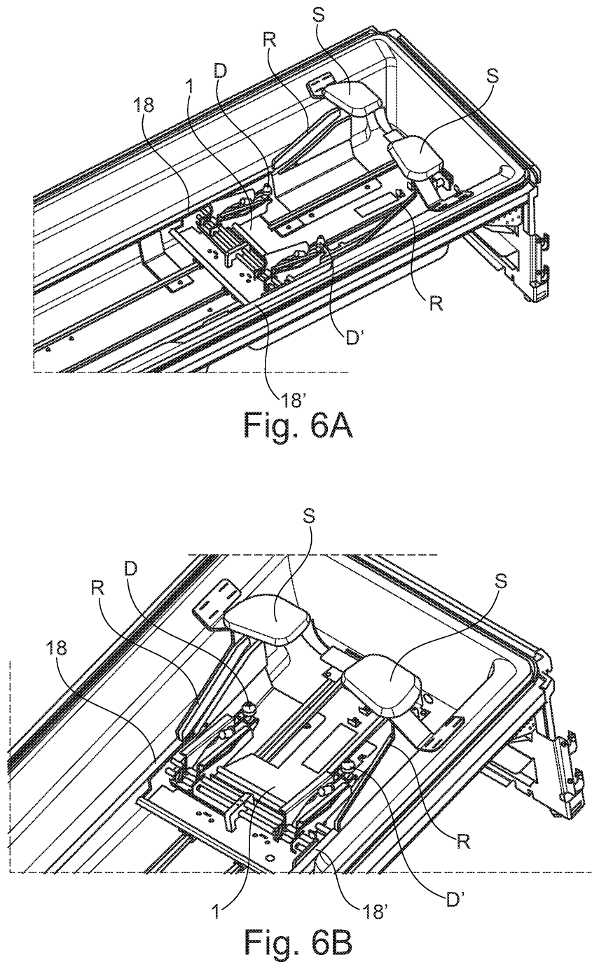

FIGS. 6A and 6B show two views of a further embodiment of the water-jet massage device according to the invention in a stage in which the nozzle cart was moved further in the direction of the head end of the device via the drive provided for this purpose.

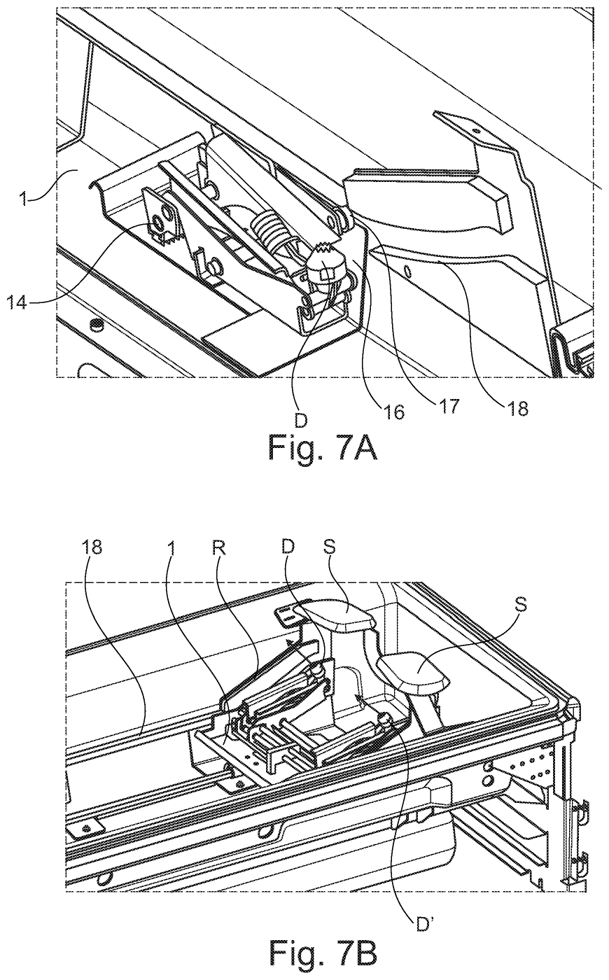

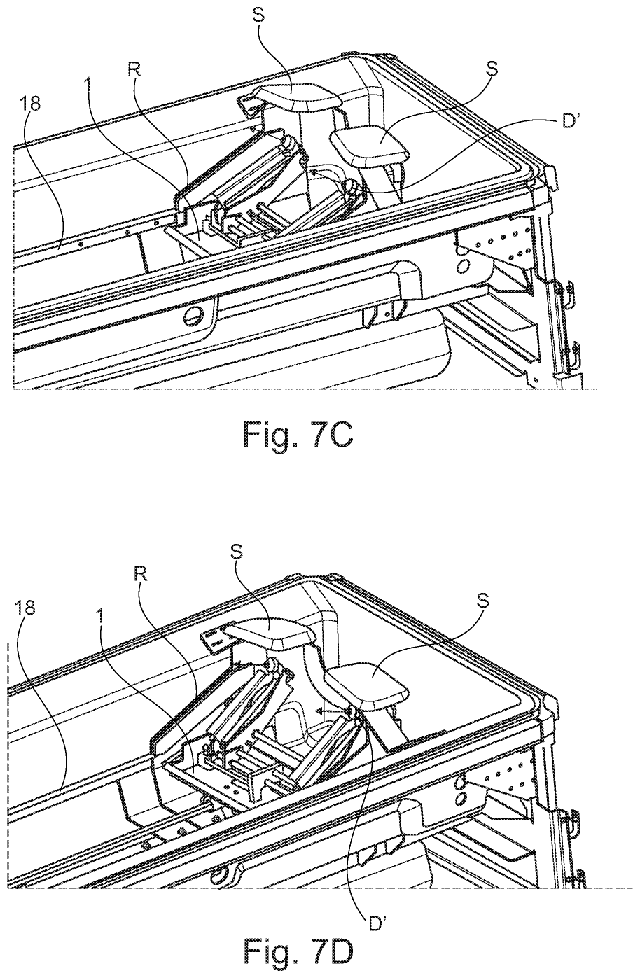

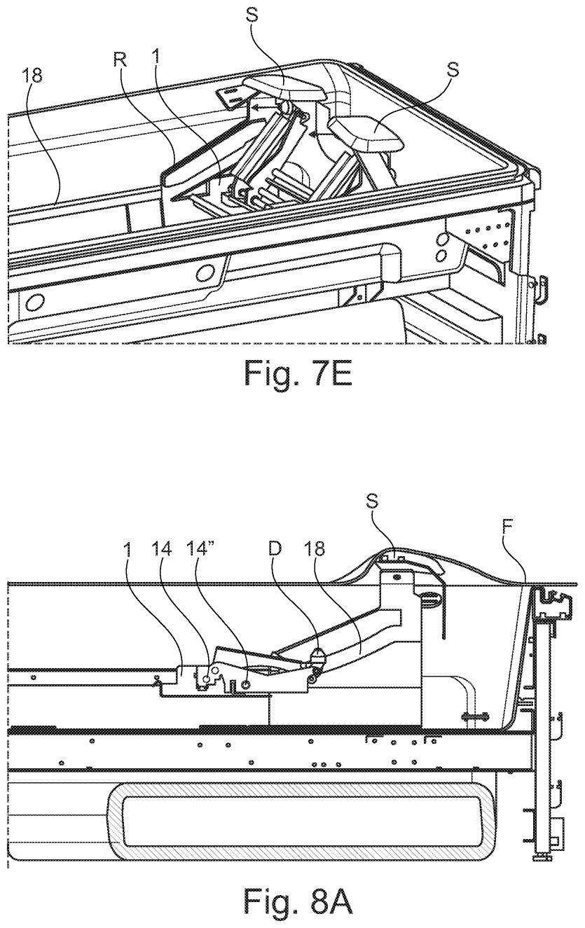

FIG. 7A to 7E show five further views of one embodiment of the water-jet massage device according to the invention, in which the nozzles of the nozzle cart are moved to the head end of the tub with the aim of ejecting massage water into concave cavities formed in the bottom side of the liner film, where the rolling wheels of the tilting plates are moved over a ramp rising in the direction of the head end of the tub from the position near the rails on the tub bottom and the angle of incidence of the water jet ejected onto the bottom side of the film is reduced from a value of 90°, i.e. perpendicular to the bottom side of the film, to acute angles, preferably reduced to a value of the angle of incidence of <10°, for example about 6°.

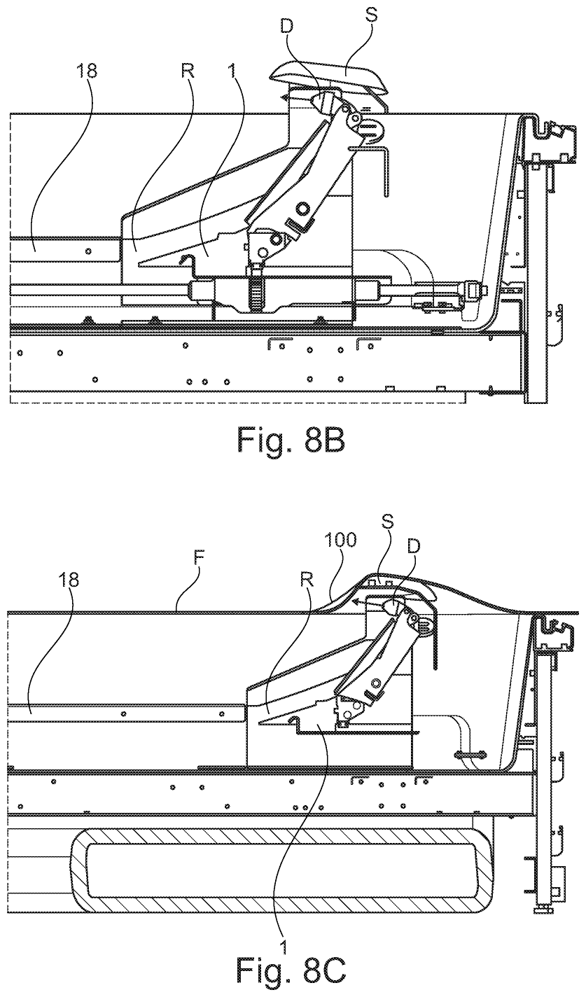

FIG. 8A to 8C show three further views of the same process as shown in FIG. 7A to 7E, but in a side view.

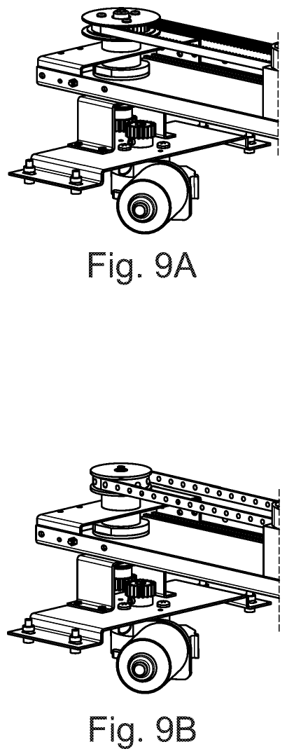

FIG. 9A to 9B show an example of drives for moving the nozzle cart in the longitudinal direction of the tub, i.e. a toothed belt and a metal perforated belt.

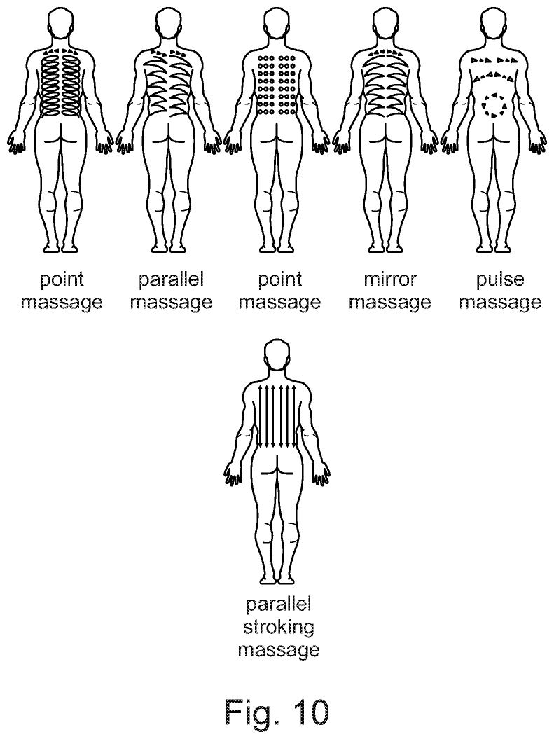

FIG. 10 shows, by way of example, sketches of possible massage images on the person to be massaged that can be executed by the water-jet massage device according to the invention.

Reference is now made to FIGS. 1A and 1B. FIG. 1A shows a device V for dry water-jet massage according to the prior art, for example a device such as has been on the market for a long time under the name “HYDROJET” and is offered by Wellsystem GmbH; and FIG. 1B shows a device for dry water-jet massage according to the present invention.

Such devices V for dry water-jet massage—reference is made to the introduction of the description for the definition of this term—usually consist of a tub W, the interior of which is designed for permanent contact with water or aqueous liquids, for example with regard to temperature, leak tightness, and rust resistance. Such a device V is usually provided with a film material F serving as a cover and at the same time as a lying surface, which film material is fastened and stretched in a closed and thus liquid-tight manner on the top edge of the tub W, in order to protect against water splashing around and exiting from the tub W on the one hand and to serve as a lying surface for a person Pe to be treated on the other hand. The elasticity of the material of the film F not only allows the person Pe to be treated to comfortably climb on and off the film F and the person Pe to be treated to lie comfortably, but it also allows a pressure pulse to be transmitted to the person Pe on the bottom side of the film F of a water jet (or a plurality of water jets) impinging from the film surface onto the body of the person Pe lying on the film material F. Further requirements of this film material F are particularly hygienic: The material must be suitable to be treated with means intended for cleaning and disinfection purposes. In addition, the film material F should also be permeable to heat transported by the water jet. This means that the massaging effect of the water jet pulse can be intensified by the heat applied—provided that it is desired by the person PE to be treated or prescribed by the person performing the treatment. A person skilled in the art knows numerous materials that can be used for the desired purposes for the cover/liner film F and can easily test and select them for their suitability on the basis of the specified parameters. Natural rubber has proven to be particularly advantageous as the material for the cover/liner film F, and natural rubber films are therefore preferred, optionally with a carrier layer made of chlorosulfonated polyethylene (CSM).

FIG. 2A shows a perspective view of the film material tub cover W in the tensioned state (as arranged on the top side of the tub W) from above, and FIG. 2B is a perspective view of the film material tub cover in the tensioned state (as arranged on the top side of the tub W) shown from below.

According to the invention, the film material F has one or more cavity/cavities 100 on the bottom side of the film, which run in the transverse direction, being directed at the person Pe lying on the film material M, and shaping the film F into one or more elevated portions 100, which are convex on the top side of the film. In preferred embodiments of the invention, one cavity or two cavities, three cavities, four cavities, or even more cavities can be formed. Very particularly preferably, the film material F has two cavities on the bottom side of the film, which run in the transverse direction of the film F, are directed at the person Pe lying on the film material F, and shape the film F into one or more elevated portions 100, which are convex on the top side of the film. By way of example, but not by way of limitation, there are two such cavities extending in the transverse direction on the bottom side of the film in FIG. 1B, directed at the person Pe lying on the film material F, and shaping the film F into two elevated portions 100, which are convex on the top side of the film as can be seen in FIGS. 2A and 2B.

The production of such “bumps” appearing on the film top side (see FIG. 2A) as convex elevated portions 100 and on the film bottom side (see FIG. 2B) as concave cavities 100 can be done in any manner known to a person skilled in the art and practically depends on the material used for the film F. In the preferred embodiment of a natural rubber film, shaping corresponding to the “bumps” can take place simultaneously with the production of the film, for example in a vulcanizing process: Tools with the appropriate shapes are matched to one another, leaving a suitably selected cavity between two tool halves, wherein the thickness of the film corresponding to the cavity left can be selected by a person skilled in the art according to the circumstances. The elevated portions and depressions forming the bumps are provided on the desired parts of the tools, for example to form a film shown in FIGS. 2A and 2B. The cavity is filled with the polymer for the production of the film material F, and the filled polymer layer is polymerized or vulcanized under the appropriate conditions (for example with heating or with the use of vulcanizing aids). The finished film provided with the cavity/cavities is then removed after the polymerization or vulcanization has ended. The production of such films and suitable devices for use in the production are known to a person skilled in the art and can be provided for the present invention in accordance with the circumstances, without the present invention imposing any restrictions on this.

In principle, a person skilled in the art can freely choose the position of the elevated portions/depressions/bumps 100 in the region of the film material. With regard to the function of also (with a lying person Pe as shown in FIG. 1B) reaching vertical parts of the body of the person to be massaged with the water jets of a dry water-jet massage, such elevated portions/depressions/bumps 100 are attached, for example in the regions of the film F which correspond to the shoulders, the soles of the feet, the inside and outside of the arms, and the inside and outside of the legs of the person Pe lying on the film material F. The elevated portions/depressions/bumps are preferably attached in the regions of the film F which correspond to the shoulders or the soles of the feet of the person Pe lying on the film material F. Accordingly, the two FIGS. 2A and 2B show the (non-limiting) example that two elevated portions/depressions/bumps 100 are preferably attached, for example in the regions of the film F which correspond to the shoulders of the person Pe lying on the film material F. As a rule, the film arranged on the top side of the tub W is therefore produced in such a way that the elevated portions/depressions/bumps 100 are located at a location on the film F that is one of the regions indicated above for the dry water-jet massage (i.e. the shoulders of the person Pe in the case of the cases shown in FIGS. 1B, 2A and 2B).

In preferred embodiments of the invention, which can be realized alone or in combination together with another embodiment or another feature or with a plurality of or all other embodiments or features of the invention, without being limited thereto, in the dry water-jet massage device V according to the invention, the cavity/cavities of the film material F have a concave round shape or a concave longitudinal shape (see FIG. 2A, 2B) on the bottom side of the film with a depth in the range from 1 mm to 200 mm, calculated from the inner surface of the film material F, and preferably with a depth in the range from 1 mm to 100 mm, which cavity/cavities run in the transverse direction, being directed at the person Pe lying on the film material F and shaping the film F into one or more, preferably two, elevated portions 100, which are convex on the top side of the film. This is advantageous according to the invention because water jets ejected at this depth from one of the nozzles D, D′, D″, D′″ into the cavity/cavities can exercise a particularly good massage effect on vertically arranged regions of the body of the person Pe lying on the film.

The invention is further explained below with reference to concave recesses/cavities 100 as shown in FIG. 2A and in FIG. 2B. The features shown and described for the inclusion of such concave recesses/cavities 100 shown in FIGS. 2A and 2B are, however, not restrictive, but are exemplary and are only intended to serve to better understand the invention.

As can be seen from FIG. 3, concave recesses/cavities 100 “on” the film surface on which the person to be treated P/the patient lies, are placed in such a way that the person to be treated P/the patient lies on the film F in such a way that his/her shoulders come to rest on the “foot” side of the two concave formations/cavities 100 or lean against the “foot” side. As an alternative to this or together with it (not shown), concave recesses/cavities 100 are placed “on” the film surface on which the person to be treated P/the patient lies, such that the person to be treated P/the patient can lie down on the film F, such that his/her inner side of the arm come to rest on the right or left side of the two concave formations/cavities or lean against the right or left sides. As an alternative to this or together with it (not shown), concave recesses/cavities 100 are placed “on” the film surface on which the person to be treated P/the patient lies, such that the person to be treated P/the patient can lie down on the film F, such that his/her soles come to rest on the “head” side of the two concave formations/cavities or lean against the “head” sides of the concave formations/cavities.

In this position of the person Pe to be massaged/the patient, all parts of the body of the person Pe to be massaged can be treated as before by a dry water-jet massage, which parts of the body can come into contact with the film material when the person Pe to be treated/the patient is lying down (as before): As is known to a person skilled in the art, by moving the nozzle cart 1 in the longitudinal direction of the tub W with the aid of a corresponding motor 2 and by displacing the at least two nozzles D, D′ arranged displaceably on the nozzle cart 1, perpendicular to the longitudinal direction of the tub by means of the spline shafts 5, 5′ which are rotatable about their longitudinal axis by one or more suitable motor(s) 2′, 2″, the massage patterns shown below in FIG. 10 are generated on the bottom side of the film material F and the pressure pulses and the heat of the massage medium (e.g., the water) are transmitted by means of the film material F onto the parts of the body coming into contact with the film material F of the person Pe to be treated/the patient.

In this way, patterns of dry water-jet massage can be generated, as can be seen from FIG. 10 and the massage experiments described below.

Thus, it is possible (left sketch in FIG. 10) to give the person to be treated a circle massage. For this purpose, the nozzle carriage 1 is slowly moved in the longitudinal direction of the tub, while the two spline shafts are slowly moved back and forth in mirror image (clockwise or counterclockwise) to one another. In this way, the two nozzles create a spiral movement that is mirror-inverted to one another. The person Pe to be treated is thus given a spiral circle-shaped massage, for example on his back.

The parallel massage image in FIG. 10 (second figure from the top from the left) results from a slow movement of the nozzle carriage 1 in the longitudinal direction of the tub and parallel zigzag movement of the nozzles D, D′ by parallel control of the spline shafts 5, 5′ (i.e. together clockwise or together counter-clockwise).

Correspondingly, the mirror image massage in FIG. 10 (fourth figure above from left) results from slow movement of the nozzle carriage in the longitudinal direction of the tub and mirror-image zigzag movement of the nozzles D, D′ by controlling the spline shafts 5, 5′ in opposite directions (i.e. clockwise for nozzle D and counter-clockwise for nozzle D′ and vice versa).

Correspondingly, point massages (FIG. 10, third figure above from the left) can be given by subsequent massaging, in each case for a specific time, while locking the nozzles (i.e. for the time of the massage of the specific point neither moving the nozzle carriage in the longitudinal direction of the tub nor displacing the nozzles in the direction transverse to the longitudinal direction of the tub).

Parallel stroking massages (see FIG. 10, figure below) are given by successively setting the nozzles D, D′ to one point each (in the direction transverse to the longitudinal direction of the tub) by locking the spline shafts 5, 5′ and moving the nozzle carriage back and forth in the longitudinal direction of the tub in each case, subsequent readjustment of the nozzles in the direction transverse to the longitudinal tub direction by means of spline shafts 5, 5′, and again moving the nozzle carriage 1 back and forth in the longitudinal direction of the tub, etc.

The massage patterns mentioned are only examples, and the invention is not limited to these patterns. A person skilled in the art will recognize that by arbitrarily combining the movements (i.e. moving the nozzle carriage in the longitudinal direction of the tub and laterally displacing the nozzles by means of the spline shafts 5, 5′ in the direction of the longitudinal walls of the tub or away from them, in each case by means of suitable motors 2) any jet combinations can be generated (including asymmetrical or even spontaneously generated arbitrarily).

In a manner known to a person skilled in the art, it is possible to control the (electric) motors 2, 2′, 2″ manually or electronically so that specific massage patterns can be preprogrammed and carried out on the person to be treated as desired or required and even carried out repeatedly.

This makes it possible according to the invention to use the device described in detail above for body massage, specifically for dry body massage of a person to be treated by means of water jets, the pulse of which is transmitted to the bottom side of the liner film/covering film and from there to the person lying on the film. In principle, it is also conceivable to massage only part of the body of a person to be treated, who requires a dry water-jet massage treatment, or to massage a body of an animal to be treated.

According to the invention, the device for dry water-jet massage further comprises a nozzle cart 1 that can be moved in the longitudinal direction of the tub W on wheels 4, 4′, 4″ on two rails that are fixed on the bottom B of the tub W. A preferred example of such a nozzle cart, which is not to be understood as a restriction of the invention and serves primarily for a better and more understandable description of the invention, can be seen from FIGS. 4A and 4B. The wheels 4, 4′, by means of which the nozzle cart 1 travels on the two rails fixed on the bottom B of the tub W and is moved in the longitudinal direction of the tub W, have wheel axes which are arranged transversely to the direction of movement of the nozzle cart 1. According to the invention, the nozzle cart can be moved on four or six or eight wheels, the axes of which are arranged in such a way that the load can be evenly distributed over the entire nozzle cart. Accordingly, the full load of the weight of the nozzle cart and the load of the pulse forces exerted by the ejection of the massage water from the nozzles on the bottom side of the film material F lie on the wheels 4, 4′ and is transferred on the two rails on the bottom of the tub W. Although it is not absolutely necessary that the wheels 4, 4′ on both sides of the nozzle cart 1 drive “in a left and right lane” on the rails, it is preferred if the wheels drive on the rails “on track.” A significant advantage is the uniform load distribution and load transfer from the nozzle cart 1 to the wheels 4, 4′ and from these to the two rails.

In addition to the load-bearing wheels 4, 4′ described above on the nozzle cart, a wheel 4″ or a plurality of wheels 4″ can be attached to both sides of the nozzle cart 1 or a plurality of wheels 4″ can be attached to one side of the nozzle cart, whose axes are arranged vertically and which move laterally on a rail or on both rails or on two sides of a rail and thus keep the nozzle cart “on track” or on the rail. A person skilled in the art knows from the requirements that arise in individual cases whether such wheels 4″ should or must be provided and can accordingly advantageously provide such wheels 4″ to ensure a permanent and reliable run of the nozzle cart 1 on the rails and also select their number.

According to the invention, a drive 3 is provided on the device V for dry water-jet massage for the forward and backward movement of the nozzle cart 1 on the wheels 4, 4′, 4″ in the longitudinal direction of the tub W. A person skilled in the art knows suitable drives 3 from the prior art and can select them based on their technical knowledge according to the circumstances without being subject to restrictions when selecting a drive 3. Examples of corresponding drives 3 are toothed belts (see FIG. 9A), steel belts provided with perforations (see FIG. 9B), chains, ropes (e.g. wire ropes), a trapezoidal thread spindle, a toothed rack, and others. For such drives 3, a drive motor 2 is usually provided (also within the scope of the invention), which drive motor is arranged outside the wet area of the tub W. The drive motor 2 outside the tub transmits a rotary movement from the outside of the tub W, for example from the bottom of the tub W, into the tub W via an interlocking gear combination, as known to a person skilled in the art from conventional power transmission devices, to a deflection roller 11. The deflection roller 11 rotates about an axis that is perpendicular to the longitudinal direction of the tub (substantially vertical in the device in operation) and transmits its rotary movement into a translational movement of the nozzle carriage or nozzle cart 1 in the longitudinal direction of the tub W. Usually there are two such deflection rollers, one of which is arranged at the head end of the tub W and one at the foot end of the tub W, for example. One or both deflection roller(s) can be driven by a drive 3 each, or an embodiment can be selected in which only one of the deflection rollers is driven by a drive 3 and the other runs along “passively.”

In a preferred embodiment of the invention, the rotary movement of the deflection roller(s) is transferred into a translational movement of the nozzle carriage 1 in the longitudinal direction of the tub by means of a toothed belt (see FIG. 9A). The toothed belt engages in a corresponding gear in the driven deflection roller on the one hand and in the nozzle carriage 1 on the other. A rotation of the deflection roller moves the toothed belt in the longitudinal direction of the tub. The toothed belt 12 moves the nozzle carriage on both tracks of the guide rail, also in the longitudinal direction of the tub.

In another preferred embodiment of the invention, the rotary movement of the deflection roller(s) is transferred into a translational movement of the nozzle carriage 1 in the longitudinal direction of the tub W by means of a perforated belt (see FIG. 9B), for example a perforated stainless steel belt. The perforated belt 13 engages in the elevations on the guide region of the corresponding deflection roller on the one hand and in the nozzle carriage 1 on the other hand. A rotation of the deflection roller 11 moves the perforated belt in the longitudinal direction of the tub, and the perforated belt moves the nozzle carriage 1 on the guide rails also in the longitudinal direction of the tub.

In further preferred embodiments of the invention, the transfer of the rotary movement of the deflection roller(s) into a translational movement of the nozzle carriage 1 in the longitudinal direction of the tub can also be carried out in the manner described in more detail above by means of other transfer means than a toothed belt 12 and a perforated belt 13. A person skilled in the art knows such transmission means and can provide, for example, a chain or a rope, for example a wire rope, a trapezoidal thread spindle, a toothed rack, or other comparable means.

According to the invention, the nozzle cart 1 carries the nozzles which eject the massage water onto the bottom side of the film material F. According to the invention, at least two nozzles D, D′, D″ are provided on the nozzle cart 1.

In principle, according to the invention, the number of nozzles is not restricted. Thus, two, three, four or even more nozzles can be arranged on the nozzle cart 1 or be included in the device V according to the invention for dry water-jet massage. However, for reasons of reliable operability of the water-jet massage device V according to the invention, it has proven useful to provide at least two nozzles D, D′. In further preferred embodiments of the invention (on and therefore with the nozzle cart 1), these cannot only be moved in the longitudinal direction of the tub, but can also be moved in the transverse direction to the longitudinal direction of the tub by means of a mechanism to be described separately below, which—as will be described as follows—leads to the fact that these (preferably two) nozzles D, D′ can be moved in the longitudinal direction of the tub W and in the transverse direction of the tub W independently from one another or with the same movement pattern. This creates the possibility of generating a large number of dry water-jet massage patterns by means of the water jets ejected onto the bottom side of the film material F on the bottom side of the film F (and consequently also on the body of the person Pe to be massaged). This means that the type of dry water-jet massage can be selected using a variety of such massage patterns.

In further preferred embodiments of the invention, which can be realized alone or in combination together with another embodiment or another feature or with a plurality of or all other embodiments or features of the invention, without being limited thereto, a further nozzle D″ is attached to the nozzle cart 1 in addition to the at least two nozzles D, D′. This further nozzle D″ can preferably be arranged in a fixed manner on the nozzle cart 1. This additional nozzle D″ on the nozzle cart 1 would thus eject massage water onto the bottom side of the film material F in such a way that the massage pattern can only be varied in the longitudinal direction of the tub W by the translational movement of the nozzle cart 1 with the nozzle D″ fixedly attached thereon. As a result, if the additional nozzle D″ continuously ejects massage water onto the bottom side of the film material F, i.e., it would produce a water-jet massage pattern running in the form of a straight line along the longitudinal direction of the tub. This additional nozzle could, however, also be operated in such a way that it could basically eject the massage water in the line massage pattern described above, but it is operated in such a way that it ejects its water jet—at a specific position of the nozzle cart 1 with a fixed water jet ejection direction of the nozzle D″ and, if necessary, when the translational movement of the nozzle cart is stopped under the concave cavity 100—exactly into one of the concave cavities 100/bumps on the bottom side of the film F. In such an operation, a “special massage” independent of the other massage actions of the device V for dry water-jet massage could be effected for the body parts of the person Pe to be massaged, which are adjacent on the top side of the film to the concave cavity 100 on the bottom side of the film or the concave cavities 100 on the bottom side of the film.

In the device for dry water-jet massage according to the prior art (FIG. 1A) shown in FIG. 1A, a multi-part nozzle cart is arranged on a double-track guide rail which is fixed to the bottom of the tub W, which nozzle cart can be moved on wheels on the double-track guide rail parallel to the longitudinal axis of the tub W (defined here and in the following also for the present invention as “X direction”). The nozzle cart of this prior art consists of a top part with one or more fixed nozzle(s) and a bottom part with a device that can be operated via a rotating toothed belt system for moving the nozzles in a more or less perpendicular direction to the X direction, at least at an angle lying between 30 and 60° to the X direction (defined here and in the following also for the present invention as “Y direction”). By operating the last-mentioned device causing a movement of the nozzles in the Y direction, the massage water jet can be directed over an area which is defined by the length of the movement of the one or more, usually two, nozzle(s) on the nozzle cart by the displacement in the X direction and by the respective movement of the nozzle(s) by the displacement in the Y direction. The disadvantage of this solution is that only one massage “corridor” of the two nozzles that is comparatively narrow in the Y direction can be exposed to water and—with a plurality, for example two, nozzles only one completely identical movement displaced only in the Y direction (and thus massage actuation) of the nozzles can be realized.

This solution, which is already progressive compared to an even earlier solution, provides a different approach to the present invention: Surprisingly, this allows a completely independent movement of the nozzles at least in the transverse direction of the tub W and thus allows—as will be described in detail below—a large number of new massage forms for dry water-jet massage (see FIG. 10). In addition, at least two nozzles D, D′ carried by the nozzle cart 1 can also eject water-jet massage water into the cavities 100 formed on the bottom side of the film material F and thereby also massage locations of the body of the person Pe to be massaged which are vertical (i.e. are arranged more or less at right angles to the surface of the film material F), such as the shoulders or soles of the feet of the person to be massaged. This was not possible with the previously known water-jet massage devices.

According to the invention, the device V for dry water-jet massage further comprises a nozzle cart 1. This is described in more detail below with reference to FIGS. 4A and 4B. The nozzle cart 1 comprises, parallel to the tub bottom B, a horizontal base plate 10 which can be moved in the longitudinal direction of the tub on the wheels 4, 4′, 4″ and has a vertical side plate 12, 12′ fixed to the bottom plate 10 in each case on the left and on the right. A first pivot axis 14 running in the transverse direction of the tub W and optionally a second pivot axis 14′ running in the transverse direction of the tub W and being offset from the first pivot axis 14 and being able to serve for guiding purposes rigidly connects the vertical side plates 12, 12′ together.

The device V for dry water-jet massage further comprises a vertically extending tilting plate 16, 16′ on each of the outer sides of the side plates 12, 12′, each mounted so as to be pivotable about the first pivot axis 14 running in the transverse direction of the tub W on each of these side plates 12, 12′. A connecting support 16a attached horizontally on the bottom side of the two vertical tilting plates 16, 16′ and a rigid axis 14″ running in the transverse direction of the tub W rigidly connect the tilting plates 16, 16′ to one another. Furthermore, each of the tilting plates 16, 16′ has an rolling wheel 17, 17′ on the outside (in the transverse direction) at the end of the tilting plate lying opposite the tilting plate stop in each case with one wheel axis parallel to the first and second pivot axes 14, 14′.

As can be seen from FIGS. 4A and 4B, the two tilting plates 16, 16′ are connected together with the horizontal connecting support 16a and the rigid axis 14″ to form a rigid unit that is pivotable about the horizontal pivot axis 14. The nozzle holders DH carrying the nozzles D, D′ are also pivotable about the pivot axis 14 and are raised from the horizontal “idle position” under the action of the rigid, also horizontally extending axis 14″, as soon as the nozzle cart 1 with the rolling wheels 17, 17′ arranged on the tilting plates 16, 16′ and running on the additional rails 18, 18′ and the ramps R is moved up the ramps R. The additional optional second pivot axis 14′, which also runs in the transverse direction of the tub W and is offset to the first pivot axis 14, allows the nozzles to be raised for alignment with the recesses/cavities 100 of the film material F and subsequent ejection of water into them for massage purposes can take place not only depending on the rise of the rolling wheels 17, 17′ on the ramps R, but, due to the offset arrangement of the two horizontal pivot axes 14, 14′, can be translated into a disproportionate lifting (compared to the rise of the rolling wheels 17, 17′ up the ramps). This advantageously ensures that the water ejection direction of the nozzles D, D′ in the nozzle holders DH can be changed from (substantially) vertically upward (starting position, compare FIG. 7A, 7B, 8A) with comparatively little effort and simple mechanical means, via a transition position (compare FIG. 7C, 7D), to (substantially) horizontal in the direction of the foot end of the tub W (ejection position, compare FIG. 7E, 8B). In the ejection position, the massage water is substantially ejected into the recesses/cavities 100 in the film material F, thus causing a massage of the parts of the body of the person Pe to be treated which are adjacent to the bulges/cavities 100. This is shown by way of example for massaging the shoulder of a person Pe to be treated in FIG. 8C, where “F” denotes the film as a whole and the bulge/cavity is denoted “100.”

The main advantage of this construction of the nozzle cart 1 according to the invention is that it allows massage water to be directed not only vertically (i.e. at an angle of substantially 90° in relation to the bottom side of the film) onto the bottom side of the film material, while the nozzle cart, and with it the at least two nozzles D, D′, is moved in the longitudinal direction of the tub W and the at least two nozzles D, D′— as explained in detail below—are moved in the transverse direction of the tub W in order to achieve a desired massage pattern (see FIG. 10) on the bottom side of the film material F and thus also on the body of the person Pe to be massaged. Rather, in addition (and in contrast to the prior art), the at least two nozzles D, D′ on the nozzle cart 1 can be moved out of the plane of the base plate 10 by means of the pivotable tilting plates 16, 16′ and thus also eject their massage water jet in special positions of the nozzle cart 1 into the cavities 100/bumps/bulges formed on the bottom side of the film material F. This is described in detail below.

As in the prior art, according to the invention, the nozzle cart 1 comprised by the device V for dry water-jet massage has at least two nozzles D, D′, D which can be moved on the nozzle cart 1 and can be fed via a flexible hose connection with massage water from the tub W by means of a pump P in order to eject one water jet per nozzle against the bottom side of the film material F and/or against the cavities on the bottom side of the film. The pump for feeding massage water from the tub W into the at least two nozzles can be a conventional pump for pumping liquids into the at least two nozzles D, D′, as is known to a person skilled in the art and can be selected according to the requirements of the individual case. Its output on the delivery side is connected to the nozzle input of the at least two nozzles D, D′ with preferably flexible hoses made of a material that is adapted to withstand continuous operation in the massage water. When the device V for dry water-jet massage is in operation, the at least two nozzles then eject massage water substantially perpendicularly onto the bottom side of the film material F and/or against the cavities on the bottom side of the film.

The movement of the at least two nozzles D, D′ forward and backward in the longitudinal direction of the tub W takes place with the movement of the nozzle cart 1. If the nozzle cart 1, driven by a motor 2 via the drive 3, is moved on the wheels 4, 4′ in the longitudinal direction of the tub W, the at least two nozzles D, D′, D″ mounted on the nozzle cart 1 next to one another in the width direction of the tub W also move parallel to one another in the longitudinal direction of the tub W. During operation of the pump (without transverse movement of the at least two nozzles D, D′, D″), two/three massage water jets would be ejected from the at least two nozzles D, D′, D″ hitting parallel to one another in the longitudinal direction of the tub W on the bottom side of the film.

Regardless of the movement of the at least two nozzles D, D′, D″ in the longitudinal direction of the tub, the movement of the at least two nozzles D, D′ in the transverse direction of the tub W can take place in that two spline shafts 5, 5′ running parallel to the longitudinal axis of the device V through a bushing LB on the bottom side of the nozzle cart 1 are controlled by a drive for executing a rotating back-and-forth movement about each spline shaft longitudinal axis.

According to the invention, the two spline shafts 5, 5′ are mounted on the head side in a bearing L, L′ lying inside the tub so as to be rotatable about their own axis and are controlled on the foot side by a drive motor lying outside the tub W to perform the rotating back-and-forth movement about each spline shaft longitudinal axis.

Furthermore, the two spline shafts 5, 5′ are each in engagement with a gear ZR, which is arranged on the bottom side of the nozzle cart bottom and has a gear axis concentric with one of the spline shafts 5, 5′. In addition, the two gears ZR that are each engaged with a spline shaft 5, 5′ are in turn engaged with toothed racks Z that are arranged parallel with two pivot axes 14, 14′, 14″ on the lower nozzle holders DH and cause an independent movement of the nozzles in the transverse direction of the tub along the pivot axes 14, 14′, 14″.

In further preferred embodiments of the invention, which can be realized alone or in combination together with another embodiment or another feature or with a plurality of or all other embodiments or features of the invention, without being limited thereto, at least one drive motor 2′ (arranged outside the tub W) is thus able to control one or both of the spline shafts 5, 5′ independently from one another to carry out a back-and-forth rotation about each spline shaft axis running along the longitudinal direction of the tub W. The spline shafts 5, 5′, which are mounted in each case on the two spline shaft ends and run in each case through each bushing, are not supported by the bushings LB, but run through them (when the nozzle cart 1 is moved along the longitudinal direction of the tub W) substantially without contact. In each case, a gear wheel ZR arranged below the nozzle cart bottom, the gear wheel axis of which is concentric to the respective axis of rotation of the associated spline shaft 5, 5′, is moved back and forth with a back-and-forth movement of the associated spline shaft 5, 5′. Each of the at least two nozzles D, D′, D″ arranged on the nozzle cart 1 has a nozzle holder DH connecting the lower end of the respective nozzle to the nozzle cart. Each of the nozzle holders DH is provided with a toothed rack Z arranged in the transverse direction (i.e., parallel to the pivot axes 14, 14′, 14″). Each of the two toothed racks Z is in engagement with the associated gear ZR which is arranged below the nozzle cart bottom and extends through a gap in the nozzle cart bottom above the nozzle cart bottom. As a result, the clockwise or counter-clockwise movement (viewed along the spline shaft axis) of the two spline shafts 5, 5′ when controlled by the spline shaft drive via the at least one motor 2′ is converted into a corresponding clockwise or counter-clockwise movement of the respective gear ZR. The two gears ZR, which are in engagement with one of the toothed racks Z arranged on one of the at least two nozzles D, D′, D″, set the two gears in a movement to the left or right side of the tub W, which movement is executed by the assigned nozzles D, D′ along the pivot axes 14, 14′, 14″. The movement of the two spline shafts ultimately results in a movement of the at least two nozzles D, D′ in a direction transverse to the longitudinal axis of the tub.

If the at least two nozzles D, D′ of the nozzle cart 1 are moved together with the nozzle cart 1 in the longitudinal direction of the tub W, and if the nozzles are moved—individually and independently from one another, together or in different ways—by moving the spline shafts 5, 5′ (independently from the movement in the longitudinal direction of the tub W) clockwise or counterclockwise to the right or left side of the tub W, this leads to a longitudinal movement and simultaneous transverse movement of the at least two nozzles. This transverse movement of the at least two nozzles D, D′ can be combined with the longitudinal movement of the nozzles on/together with the nozzle cart 1 to form any symmetrical or asymmetrical water-jet massage patterns on the bottom side of the film material and thus also on the body of the person Pe to be massaged (see FIG. 10).

In all of this, with regard to the functions of the spline shafts 5, 5′, it should be noted that the spline shafts 5, 5′— even via the bushings LB— do not have any load-carrying function, in particular no load-carrying function with regard to the weight of the nozzle cart 1 and do not have any “intercepting” function of the pressure pulse of the massage water ejected by at least two nozzles D, D′.

The spline shafts 5, 5′ can be any rods known to a person skilled in the art and suitable as power transmission shafts, for example two rods with a triangular or square cross section. According to the invention, two such spline shafts 5, 5′ are arranged parallel to the longitudinal axis of the device V within the tub W. According to the invention, the spline shafts 5, 5′ are preferably mounted inside the tub on the head side (i.e. on the side of the tub W on which the head of the person to be treated usually lies (compare also FIG. 1B with sketch of the person to be treated) in each case in a bearing L, L′ lying inside the tub so as to be rotatable about the axis. The spline shafts 5, 5′ are also controlled on the foot side (i.e. on the side of the tub W on which the feet of the person to be treated usually lie (compare also FIG. 1B with the sketch of the person to be treated) by one drive motor 2′, 2″ in each case. The drive motors 2′, 2″ lie outside the tub W and can be motors known to a person skilled in the art for this purpose, which can be selected as desired on the basis of known criteria. In preferred embodiments, they are, for example, electric motors. By means of these motors 2′, 2″, the respective spline shafts 5, 5′ can be set in rotation about the longitudinal axis of the spline shafts 5, 5′, namely in a rotation in both directions (clockwise and counter-clockwise, viewed along the spline shaft axis). This allows for back-and-forth rotation of the spline shafts 5, 5′ about their longitudinal axis. As is known to a person skilled in the art, the spline shafts 5, 5′ are guided on the foot side by sealed guides from the inside of the tub W to the outside into engagement with the motors 2′, 2″.

According to the invention, at least one of the nozzles D, D′, D″ is furthermore able to direct its ejected water jet on the bottom side of the film material F onto the interior of the one or more cavities 100 on the bottom side of the film which shape convex elevated portions 100 on the top side of the film material F.

This can, as described above, be done in such a way that at least one nozzle is rigidly arranged on the nozzle cart 1 in such a way that it directs its massage water jet when it reaches a certain (adjustable) position of the nozzle cart exactly into one cavity 100 (bump) formed on the bottom side of the film.

This solution is one of the conceivable possibilities, but requires that the nozzle cart 1 must be moved into the specific position with the aim of directing the massage water jet exactly into the concave cavity on the bottom side of the film material F which allows the massage water jet ejection into the desired cavity 100/into the desired cavities 100, and also remains there for a certain time allowing for a dry water-jet massage. This is because the nozzle D′″ is rigidly arranged on the nozzle cart 1 and can therefore change the direction of the massage water jet ejection only in the longitudinal direction of the tub W together with a movement of the nozzle cart 1.

Alternatively, in a preferred embodiment of the invention, which can be realized alone or in combination together with another embodiment or another feature or with a plurality of or all other embodiments or a plurality of or all other features of the invention, without being limited thereto, the device V for dry water-jet massage comprises at least two nozzles D, D′ on the nozzle cart 1, which are able to move the nozzle cart 1 in a plane parallel to the bottom of the tub 1, spanned by the long sides and the transverse sides of the tub W to direct each ejected water jet substantially perpendicular to the bottom side of the film material F. This is done in the manner described above in that the nozzle cart 1 is moved with its wheels 4, 4′ on the rails fastened to the tub bottom in the longitudinal direction of the tub W and the two nozzles D, D′ simultaneously move the spline shafts 5, 5′ by means of the drive clockwise or counter-clockwise together or independently of each other and thereby the at least two nozzles D, D′ can be moved transversely to the longitudinal direction of the tub in the direction of the sides or in the direction of the center of the tub.

In further, even more preferred embodiments of the invention, which can be realized alone or in combination together with another embodiment or another feature or with a plurality of or all other embodiments or a plurality of or all other features of the invention, without being limited thereto, the device V for dry water-jet massage comprises on the respective left and right outer sides of the two rails fixed on the bottom B of the tub W in the longitudinal direction of the tub W in each case one additional rail 18, 18′ for moving the nozzle cart 1 for the run of the rolling wheels 17, 17′ attached on the two tilting plates 16, 16′ parallel to the run of the wheels 4, 4′, 4″ on the bottom of the tub W when the nozzle cart 1 is moved in the longitudinal direction of the tub W. The rails 18, 18′ run at one or more locations, preferably in the region of the head end and/or in the region of the foot end of the tub W, on rising ramps toward the tub end. The ramps rising toward the end of the tub are able to pivot the ends of the tilting plates 16, 16′ at the end of the nozzle cart about the first pivot axis 14 away from the bottom B of the tub W toward the film F when the rolling wheels 17, 17′ are driven uphill on the ramps, whereby the angle of each massage water jet of each nozzle D, D′ rigidly connected to the tilting plate 16, 16′ changes with the bottom side of the film with increasing pivoting of the tilting plates 16, 16′ from substantially 90° to acute angles, preferably up to an angle of <10°, for example up to an angle of 6.5°, based on the bottom side of the mat.

As a result, the at least two nozzles D, D′ on the nozzle cart 1 are able to direct each ejected water jet onto the interior of at least one of the one or more cavity/cavities on the bottom side of the film, which run in the transverse direction, are directed at the person Pe lying on the film material M, and shape the film F into one or more elevated portions 100, which are convex on the top side of the film. The person Pe who is to be subjected to a dry water-jet massage and who is to be subjected to a dry water-jet massage with his body, in particular with his vertical parts resting against the bumps 100 formed on the top of the film, receives the water-jet massage pressure pulse via the film material walls of the bumps and thus is dry massaged thereon.

This is explained in further detail below with reference to FIGS. 5, 6A and 6B, 7A to 7E and 8A to 8C.

Assuming that cavities/bumps 100 are formed on the bottom side of the film material in the region of the head, as shown in FIGS. 2A and 2B, the position of the nozzle cart 1 shown in FIG. 5A—near the foot end of the tub W and with nozzles 2, 2′ “remaining” near the tub bottom—can be the starting point of the movement for dry water-jet massage on a person to be massaged. To simplify the representation, in all of the aforementioned figures (except where explicitly stated otherwise) the film material F, which is used to cover the tub W and for the person Pe to be massaged to lie down, is not shown in the figures for reasons of simplification (exception: FIG. 8A, 8C).

Starting from the foot end of the tub W, the nozzle cart 1 with the two at least two nozzles D, D′ arranged thereon, preferably with exactly two nozzles D, D′, can travel at any speed (slower for reasons of a thorough massage) on the running wheels 4, 4′ in the direction of the head end of the tub W, i.e. in the longitudinal direction of the tub W. The speed of the movement can be in a range such that the nozzle cart 1 covers the distance between the foot end and head end of the tub once in (for example and without limitation) 1 to 2 minutes. The nozzle cart can then be moved back to the foot end of the tub W on the same path; etc. However, due to the requirements of a massage, the time can be shorter or longer in individual cases and can be set, for example, by a person monitoring the dry water-jet massage on the person Pe to be massaged. Such settings can be: both the movement of the at least two nozzles D, D′, D″ in the longitudinal direction of the tub W, as well as the movement of the at least two nozzles D, D′, D″ in the transverse direction of the tub W, as well as the movement of the at least two nozzles D, D′ with adjustment of the jet direction of the massage water jet onto one of the cavities 100 arranged on the nozzle-bottom side of the film F.

During the movement of the nozzle cart 1 with the nozzles D, D′ arranged thereon, from the foot end of the tub W to the head end of the tub W and back, one or both of the at least two nozzles D, D′ can be moved by means of one or both of the spline shafts 6, 6′ on the nozzle cart in a lateral direction, i.e. in directions transverse to the longitudinal direction of the tub. This can be done together by synchronous rotation of the spline shafts 6, 6′ in the same direction or independently from one another by asynchronous or counter-rotating rotation of the spline shafts 6, 6′ or by moving one spline shaft while the other spline shaft is stopped or by moving one spline shaft 5 quickly in any direction and by slowly moving the other spline shaft 5′ in any direction.

The respective rotation of the spline shaft(s) clockwise or counter-clockwise about the axis thereof running longitudinally to the tub W causes the same and identically directed rotation of the gear ZR in the same circular (partial) circumference, which gear is arranged concentrically with the respective spline shaft. Both toothed wheels ZR are in engagement with respective toothed racks Z arranged above the base plate of the nozzle cart 1. The latter are fastened in the transverse direction of the tub W to the lower ends of the holder of each nozzle D, D′. The toothed racks Z arranged transversely to the longitudinal direction of the tub and thus also the nozzles D, D′ are moved laterally (to the left or to the right) by the gear wheels ZR controlled by the spline shafts 6, 6′, namely along the pivot axes 14, 14′, 14′, which also run transversely to the longitudinal direction of the tub W.

The control of the transverse movement of the nozzles D, D′ by rotating the spline shafts 6, 6′ clockwise or counterclockwise is independent of the movement of the nozzles D, D′ on and with the nozzle cart 1 in the longitudinal direction of the tub. This allows a previously unknown number of water-jet massage patterns to be followed, of which only a few are shown in FIG. 10. The transverse movement of the nozzles D, D′ is not shown in any of the figures; however, a person skilled in the art understands the connection between the control of the movement of the nozzles D, D′ in the transverse direction of the tub W by moving one or both of the spline shafts 6, 6′ clockwise or counterclockwise and the actual movement of the nozzles D, D′ in the transverse direction of the tub W via the gear wheels ZR and toothed racks Z based on the above detailed description.

As long as the nozzle cart 1 with the wheels 4, 4′, 4″ on the bottom of the tub W is moved “in the plane” by means of the drive 3 and the nozzles D, D′ are moved simultaneously (or separately) laterally back and forth (transversely to the longitudinal direction of the tub) in the way described above, the massage water jet ejected from the nozzles D, D′ hits—regardless of the movement of the nozzle cart 1 in the longitudinal direction of the tub (due to the movement of the nozzle cart 1 on the wheels 4, 4′, 4″) and also independently of the more or less strong displacement of the nozzles D, D′ arranged on the nozzle cart 1 in the transverse direction of the tub—substantially perpendicular to the bottom side of the film material F on which the person Pe to be massaged lies. The body parts of the person Pe to be massaged that point to the film material and are accessible to the pressure pulse of the massage water jet are therefore massaged in the desired manner by the massage water jet that hits the film bottom side substantially perpendicularly. This process makes it possible to massage all body parts of the person to be massaged that come into contact with the material of the film F, i.e. resting on the film F, with a selectable, for example (without limitation) constant pressure of the massage water jet. This happens—mentioned in the example described above—starting from the foot end of the tub W, where, for example, as the process progresses, with the continuous displacement of at least two nozzles D, D′ on the nozzle cart 1 in the longitudinal direction of the tub W toward the head end thereof and with controlled back-and-forth movement of the at least two nozzles D, D′ in the transverse direction of the tub by a synchronous or asynchronous or completely independent repeated movement or even only individual movement of one of the at least two nozzles D, D′ by means of the spline shafts 5, 5′ the heels of the feet, the calves, the lower sides of the thighs, the buttocks, the hips, the back, the shoulder blades (possibly also the neck) of the person to be massaged are massaged dry with the massage water jets hitting the bottom side of the film substantially perpendicularly. In the event that the person Pe to be massaged lies prone on the cover film F, the corresponding front body parts of the person to be massaged can also be moved from the foot end to the head end of the tub W.

The process can be repeated by moving the nozzle cart in the reverse direction (from the head end to the foot end) and with controlled back-and-forth movement of the at least two nozzles D, D′ in the transverse direction of the tub by a synchronous or asynchronous or completely independent repeated movement or even only individual movement of one of the at least two nozzles D, D′ by means of the spline shafts 5, 5′; etc.

In this procedure, the nozzle cart 1 having the at least two nozzles D, D′ can be moved by moving on the wheels 4, 4′, 4″ with controlled back-and-forth movement of the at least two nozzles D, D′ in the transverse direction of the tub by a synchronous or asynchronous or completely independent repeated movement or even only individual movement of one of the at least two nozzles D, D′ arranged on the nozzle cart 1 by means of the spline shafts 5, 5′ from the state shown in FIG. 5 (at the foot end, nozzles in the “plane”) to the state shown in FIG. 6A, 6B (nozzles in the “plane”; nozzle cart near the head end) and back. If desired, this can be done in a plurality of consecutive cycles or in a plurality of above-described movement sequences of the movement of the nozzle cart 1 from foot end to head end or from head end to foot end with the respective return of the nozzle cart to the respective starting position on a “fast” direct path without ejecting massage water.

In a further embodiment of the invention, when the nozzle cart 1 is moved further with the at least two nozzles D, D′ arranged thereon, at least one of the at least two nozzles D, D′ arranged on the nozzle cart 1 is able to bring one or two of the at least two nozzles D, D′ into a position in which at least one of the at least two nozzles D, D′, preferably even two of the at least two nozzles D, D′, can direct each ejected massage water jet in at least one, preferably in each case in at least one of the cavities 100 formed on the bottom side of the film. Preferably, when the nozzle cart 1 is moved further with the at least two nozzles D, D′ arranged thereon, two of the at least two nozzles D, D′ arranged on the nozzle cart 1 are able to bring one or two of the at least two nozzles D, D′ into a position in which at least one of the at least two nozzles D, D′, preferably even two of the at least two nozzles D, D′, can direct each ejected massage water jet in at least one, preferably in each case in at least one of the cavities 100 formed on the bottom side of the film. This process is shown in FIGS. 7A to 7E and 8A to 8C and is described in detail below.

As shown in FIGS. 7A and 8A, additional rails 18, 18′ are arranged laterally on the outside in each case on the rails on the bottom B of the tub, on which the nozzle cart 1 is moved on the wheels 4, 4′, 4″, and parallel to the rails fixed on the bottom B of the tub W at least in the region of the head end of the tub W. In further preferred embodiments of the device V according to the present invention, these additional rails 18, 18′ run toward the respective end of the tub, in the case described here, i.e., they rise toward the head end of the tub W. The angle of rise compared to the tub bottom can be selected by a person skilled in the art in adaptation to the technical requirements, for example in adaptation to the available space requirements, and is—for example and not limiting— 10° to 60°, preferably 15° to 45°. The angle of rise can be the same over the entire length of the additional rails 18, 18′, so that the rails 18, 18′, starting from a specific location, run on a uniformly rising ramp. As an alternative to this, the angle of rise can be different over the course of the ramp, for example it can (without limitation) become larger toward the end of the ramp. A person skilled in the art can choose this according to the circumstances of the individual case and adjust it accordingly.

As soon as—as can be seen in particular from FIG. 7A—the nozzle cart 1 is moved on the rails arranged on the bottom B of the tub W on the wheels 4, 4′, 4″ “in the plane,” i.e. without lifting the at least two nozzles D, D′ by means of the tilting plates 16, 16′ and their outer rolling wheels 17, 17′, so far in the direction of the tub end—in FIG. 7A: in the direction of the head end of the tub W— that the outer rolling wheels 17, 17′ assigned to the tilting plates 16, 16′ are located at the beginning of the rail 18, 18′ rising to the ramp, every further movement of the nozzle cart 1 on the rails arranged on the bottom B of the tub W on the wheels 4, 4′, 4″ in the direction of the end of the tub W— in FIG. 7A: in the direction of the head end of the tub W— results in that the nozzle cart 1 having the at least two nozzles D, D′ arranged thereon is moved further on the wheels 4, 4′, 4″ on the rails arranged on the bottom B of the tub W toward the head end of the tub W, but the outer rolling wheels 17, 17′ assigned to the tilting plates 16, 16′ begin to “run up” on the respective additional outer parallel rail 18, 18′ on the ramps on both sides. This is shown, for example, in FIGS. 7A and 7B. The outer rolling wheels 17, 17′ and the tilting plates 16, 16′ connected to them are raised in accordance with the rise of the ramps 18, 18′ on both sides and pivoted about the pivot axis 14 in the direction of the bottom side of the film F. This pivoting process takes place on both sides of the nozzle cart with the same rise, since the tilting plates are rigidly connected via the further axis 14″. In FIG. 7B, the jet direction or ejection direction of the at least two nozzles D, D′ is schematically sketched with arrows. In FIG. 7B, it can be seen that already in this stage the angle of the massage-water ejection direction changes to a smaller, i.e. more acute angle relative to the bottom side of the film material F (substantially 90° relative to the film bottom side) compared to the ejection direction of the massage-water jet from the at least two nozzles D, D′ when moving the nozzle cart 1 with the at least two nozzles D, D′ “in the plane.”

In the course of this process, the movement of the at least two nozzles D, D′ arranged on the nozzle cart 1 in the transverse direction of the tub can be carried out independently—as described above—by rotating the two spline shafts 5, 5′ clockwise or counterclockwise around the longitudinal axis of the spline shafts 5, 5′ without being subject—as is the case in “in the plane”—to any restrictions.

During the further movement of the nozzle cart 1 having the at least two nozzles D, D′ arranged thereon in the direction—for example (without limitation)—toward the head end of the tub W on the rails on the wheels 4, 4′, 4″ arranged on the bottom B of the tub W, the outer rolling wheels 17, 1T are moved further up the ramp on the additional rail on the ramp 18, 18′. The upward movement of the rolling wheels 17, 17′ is “translated” by the offset pivot axes 14, 14c— as described above and can be seen from FIGS. 4A, 4B and 7A to 7E— into a disproportionate lifting of the tilting plates 16, 16′ with the nozzles D, D′ arranged thereon. This can be seen from the comparison of FIGS. 7C and 7D with FIG. 7B. Due to the rise of the outer rolling wheels 17, 17′ on the additional parallel rails on the ramps 18, 18′, the tilting plates 16, 16′ rise further and pivot further in the direction of the bottom side of the film about the pivot axis 14″, together with the nozzle holders and the at least two nozzles D, D′. Also in these two FIGS. 7C and 7D, the further changing jet direction or ejection direction of the at least two nozzles D, D′ is schematically sketched with arrows. It can be seen that the angle of the massage-water ejection direction with the bottom side of the film material F changes to ever smaller acute angles compared to FIG. 7B.

Finally, FIG. 7E shows that during the further movement of the nozzle cart 1 having the at least two nozzles D, D′ arranged thereon in the direction—for example (without limitation)—toward the head end of the tub W on the rails on the wheels 4, 4′, 4″ arranged on the bottom B of the tub W, the outer rolling wheels 17, 17′ are moved further up the ramp on the additional rail on the ramp 18, 18′ to the end position (shown in FIG. 7E) in the direction of the head-side end of the tub W. As the outer rolling wheels 17, 17′ continue to rise on the additional parallel rails on the ramps 18, 18′, the tilting plates 16, 16′ rise further to the end position shown in FIG. 7E and pivot in the direction of the bottom side of the film about the pivot axis 14″, together with the nozzle holders and the at least two nozzles D, D′. FIG. 7E shows that—in comparison to FIGS. 7C and 7D— the angle of incidence of the massage water jet on the bottom side of the film is further reduced relative to the course of the bottom side of the film in the end position of the nozzle cart 1 with the at least two fully opened nozzles D, D′. In FIG. 7E, the (optional) support surfaces S for the covering film and liner film F are also identified separately.

The same sequence of upward movements of the outer rolling wheels 17, 1T with pivoting movement of the tilting plates 16, 16′ about the pivot axis 14″ as shown in FIG. 7A to 7E are also shown in a side view of the nozzle cart 1 in FIG. 8A to 8C. In FIG. 8A to 8C, the (optional) support surfaces S for the covering film and liner film F above the shoulders next to the head of the person to be massaged are also identified separately. The side views of FIGS. 8B and 8C differ only in that FIG. 8B does not show the cover and liner film F, but the cover film and liner film F is shown in FIG. 8C.

FIG. 8A shows a view of the device V according to the invention for dry water-jet massage that is comparable to FIG. 7A, but in a side view of the nozzle cart 1. In the side view shown in FIG. 8A, the nozzle cart 1 is shown with the at least two nozzles D, D′. Up to this point, the nozzle cart 1 has moved in the longitudinal direction of the tub W from its foot end in the direction of the head end of the massage tub W “in the plane,” i.e. while moving on the rails arranged on the tub bottom by means of the wheels 4, 4′, 4′ in the longitudinal direction of the tub W. The at least two nozzles D, D′ arranged on the nozzle cart 1 therefore move in the longitudinal direction of the tub W together with the nozzle cart 1 and on the nozzle cart 1. At the same time, up to this point, the at least two nozzles D, D′ are displaced in the transverse direction of the tub by means of the two spline shafts 5, 5′ by rotating them about their axis of rotation running in the longitudinal direction of the tub in the lateral direction (=transverse direction of the massage tub W) on the nozzle holders DH moved to the outside (i.e. in the direction of the side tub walls) or inward (i.e. away from the side tub walls) along the pivot axes 14, 14′, 14″. The massage water impinging at a(n) (almost) right angle on the bottom side of the covering or liner film F exerts—as described above—a massage pulse on the bottom side of the covering film or liner film, which is transmitted to the body of the person Pe, lying on the film F, and massages this person in this way.

The position of the nozzle cart 1 shown in FIG. 8A is the one at which the outer rolling wheels 17, 17′ on the outside of the two tilting plates 16, 16′ begin to drive “uphill” in the direction of the head end of the tub, during the further displacement of the nozzle cart 1, on the additional outer rails 18, 18′ on a ramp and thus to pivot the two tilting plates 16, 16′ together about the pivot axis 14 out of the plane in the direction of the bottom side of the film. In the context of this pivoting movement, the continuation of which is shown with further uphill driving of the outer rolling wheels 17, 17′ and further pivoting of the tilting plates 16, 16′ in FIGS. 8B and 8C, the water jet ejection direction of the at least two nozzles D, D′ changes from the (substantially) right angle in relation to the bottom side of the film (as can be seen from the sequence in FIG. 7A to 7E) to smaller, substantially too small, acute angles, more preferably to angles <10°.

This is also shown in FIGS. 8A, 8B, and 8C: While the angle, based on the bottom side of the film, is approximately 90° in FIG. 8A, the ejection angle in FIGS. 8B and 8C is significantly smaller and is preferably a small, acute angle <10°. This leads—as can be seen from the sketch of FIG. 8C with the section of the covering film and liner film—to an angle of incidence of the massage water jet ejected by the at least two nozzles D, D′ onto the inside of the film cavities 100 of about 90° and thus to an application of a massage water pulse through at least one of the at least two nozzles D, D′ at an advantageous angle while achieving a good massage effect on the concave cavity wall for the massage of the body surface part of the person to be massaged, which part is adjacent to the wall on the top side of the film.

After this massage effect has been achieved, for a time sufficient or desired for a dry water-jet massage or at least a fraction thereof, in which a plurality of similar and similarly long massages can be combined to form an entire massage on the body parts of the person Pe to be massaged, which body parts are adjacent to the cavities 100 and which are arranged substantially perpendicular to the liner film F, when the person Pe is lying on the liner film F, for example the shoulders or the soles of the feet of the person to be massaged, the nozzle cart is moved from the position lying furthest from the head end of the massage tub (see FIGS. 8B and 8C) in the direction of the foot end of the massage tub. This can be done using the same steps of the pulse action of the water jets ejected by the at least two nozzles D, D′ in the reverse order to that described above (see FIGS. 8C, 8B and 8A or FIG. 7E, 7D, 7C, 7B, 7A) or can be done in a faster step or a plurality of fast steps in reverse order as described above. The procedure can be controlled by a person skilled in the art according to the circumstances of the given massage pattern and/or the wishes of the person to be massaged.

The process of dry water-jet massage can then be restarted according to the above description, in that it is started again to move the nozzle cart 1 and thus also the at least two nozzles D, D′ arranged on the nozzle cart 1 “in the plane” from the foot end on the rails fastened to the tub bottom by means of the wheels 4, 4′, 4″ in the direction of the head end of the tub W and at the same time to move the at least two nozzles D, D′ by means of the spline shafts 5, 5′ transversely to the longitudinal direction of the tub and thereby to create different patterns of a dry water-jet massage (see FIG. 10 for a few examples) on the parts of the body of a person to be massaged that lie on the film F and come into contact with the film F.

Such massage processes taking place “in the plane” can be combined in any number and sequence with any number (and in any order) of massage processes in the concave cavities 100 formed on the bottom side of the film. This can be adjusted by a person skilled in the art, experienced in this technical field, according to the requirements of the person Pe to be massaged, for example the wishes of the person Pe to be massaged or the treatment indication for the person to be massaged.

Furthermore, all of the massage processes described can be carried out with massage water jets with continuous, constant pressure that is pleasantly perceived by the person Pe to be treated. Alternatively, it is also possible to change the pressure in the course of the dry water-jet massage or to apply a “pulsating pressure image.” A person skilled in the art can adapt this to the circumstances and the requirements of the individual case, for example also to the physiological requirements of the person to be massaged.

In preferred embodiments of the invention (not shown in any of the drawings), which can be realized alone or with another feature of the invention or with a plurality of other features of the invention or with all other features of the invention, without restricting the invention thereto, the device V further comprises at least one nozzle D′″, which is not arranged on the nozzle cart 1 and is able to direct its ejected water jet onto the concave interior of at least one of the one or more concave formation(s)/cavity/cavities 100. This can take place in any manner known to a person skilled in the art, for example continuously or intermittently or pulsating or in a rhythm that is coordinated with the massage water ejection of the nozzles mounted on the nozzle cart 1. Due to the fact that the water jet ejected by the nozzle D′″, which is not arranged on the nozzle cart 1, is directed in a continuous or intermittent or pulsating manner or in a rhythm that is coordinated with the nozzle massage water ejections mounted on the nozzle cart 1 to the interior of at least one of a plurality of concave formation(s)/cavity/cavities 100, a continuous or intermittent or pulsating massage effect or a massage effect that is adjusted to the massage pulse of the nozzle(s) mounted on the nozzle cart can be effected on the body parts of the person Pe/the patient to be massaged with regard to the lying position of the person Pe/the patient to be treated, which are in proximity or adjacent to the at least one of the one or more concave formation(s)/cavity/cavities 100. This massage effect is obviously temporally and spatially independent of that which the nozzle(s) D, D′, D″ mounted on the nozzle cart exert on the body of the person P to be treated/on the patient. While the nozzle D′″ which is not arranged on the nozzle cart therefor ejects (or also does not eject) massage water onto the interior of at least one of the plurality of concave formation(s) 100, the nozzle cart 1 with the massage nozzles D, D′, D″ can be moved independently in the longitudinal direction of the tub or the nozzles D, D′ in the Y direction by means of the spline shafts 5, 5′ (and can thereby—as described above—independently generate any desired massage pattern of a dry water-jet massage (or not generate if the nozzles D, D′ are not moved or are not displaced)), without this having an effect on the dry water-jet massage by the nozzle D′″ of the device V according to the invention, which nozzle is not arranged on the nozzle cart 1.

In the same way as described above, the massage pulse exerted by the massage water of the nozzle D′″ can also preferably be applied to the controlled concave formation(s) and thus to the body parts of the person to be treated P/of the patient or can be changed independently of the massage pulses that are applied by the other nozzles or can also be specifically adapted to these. The same applies to the massage water temperature: This can also be selected, varied, or adapted independently.

The invention also relates to a dry water-jet massage method. In this case, the body of a person Pe to be treated/of a patient, which is arranged on a film material F as a top cover of a device V that allows a transmission of pressure pulse, as described above in detail according to the invention, is subjected for a certain time to the water jet pressure pulse ejected by at least one of the nozzles D, D′, D″, D′″ onto the bottom side of the film material F and optionally into the interior of at least one of the one or more concave cavities 100 on the bottom side of the film shaping convex elevated portion(s) 100 on the top side of the film F from at least one of the nozzles D, D′, D″ delivering the pulse, which has a massage effect on the body.

In contrast to the prior art, with the dry water-jet massage method according to the invention, not only can the above-described various flat massage images be generated on the bottom side of the liner film F, with which a massaging pressure pulse is applied via the liner film F to the body parts of the person to be treated which rest directly on the film material F. Rather, massage pulses can also be applied according to the invention to parts of the body of the person P to be treated via the one or more concave formation(s)/cavity/cavities 100 attached to the film, which are open in the direction of the bottom side of the film, which rise vertically above the surface of the liner film and which bear against the one/the plurality of concave formation(s)/cavity/cavities 100. For this purpose, either at least one, preferably one, nozzle D′″, which is not arranged on the nozzle cart 1, can be provided which is able to direct its ejected water jet onto the interior of at least one of the one or more concave recesses 100, or at least one, preferably one, nozzle D″ arranged on the nozzle cart 1, which is able to direct its ejected water jet onto the interior of at least one of the one or more concave recesses 100, or at least two D, D′ of the nozzles on the nozzle cart 1, which is/are able to direct the ejected water jet thereof in each case onto the interior of at least one or two of the plurality of concave recesses 100. This has been described in detail above, and reference is made to these above descriptions for the method according to the invention for dry water-jet massage.

As with a conventional massage or water-jet massage, the dry water-jet massage according to the invention can be carried out with the device of the present invention and used as a body massage, preferably for relieving cramps, tension (for example muscle tension), tenseness (for example stress-related muscular tenseness), for the reduction of stress (for example for the elimination of stress-related or postural hardening of the trapezius muscle), for the alleviation or elimination of pain (for example in the case of sports injuries or for the alleviation or elimination of back or joint pain, muscular imbalances, muscular fatigue, muscle tone disorders), for the improvement of blood circulation (for example for the elimination of (chronic) venous congestion syndrome or circulatory and metabolic disorders), for the treatment of cervical migraines, for the treatment of fibromyalgia, for the elimination of reversible functional disorders of the spine and for the combat of the cervical and thoracic spine syndrome and the so-called lumbar syndrome. The terms “cervical spine syndrome,” “thoracic spine syndrome,” and “lumbar syndrome” each mean a state of the presence of pain in the region of the cervical spine, thoracic spine, or lumbar spine, in each case generally and without specific indication of the cause of the pain. The respective syndromes are generally difficult to control or alleviate, but according to the invention are specifically alleviated or controlled with the new device.

Other possible uses are to use the device according to the invention to increase metabolic performance, to loosen subcutaneous cell tissue, for venous and lymphatic decongestion, to loosen scar tissue, to activate and dampen the vegetative nervous system with beneficial effects on the internal organs.

Advantages of the device V according to the invention for dry water-jet massage compared to the prior art include:
A central water pressure connection can be installed for several, advantageously two, nozzles D, D′. Both nozzles D, D′ are attached on a single nozzle carriage 1 and can be moved away from and toward one another in the transverse direction of the tub W.
The drive motors 2, 2′, 2″ can be attached outside the tub and can each drive a shaft (spline shafts 5, 5′ or a drive 3) via tolerance-compensating cross couplings.
Nozzle movements in the longitudinal direction and in the transverse direction of the tub A are simultaneously possible, can be superimposed, and allow movements of the at least two nozzles D, D′ mounted on the nozzle cart in the transverse direction of the tub W independently of one another due to the independently controllable spline shafts 5, 5′ which do not have a load-bearing function; the spline shafts 5, 5′ only serve to shift the arrangements of the at least two nozzles D, D′ on the nozzle cart 1 along the pivot axes 14, 14′, initiated by the movement of the spline shafts 5, 5′ about their own longitudinal axis.
The distance between the nozzles D, D′ in the transverse direction is continuously variable from a minimum to a maximum.
All nozzle positions can be detected from outside the tub W by measuring the angle of rotation of the spline shaft drives.
The device responsible for displacing the nozzles as well as the nozzle cart can be completely pre-assembled.

The invention has been explained above with reference to preferred embodiments only by way of example, without being restricted to the preferred embodiments.

### LIST OF REFERENCE SIGNS

B Bottom of the tub W
D, D′, D″, D′″ Nozzles
DH Nozzle holders
F. Film material
L, L′ Spline shaft bearings 5, 5′
LB Bushings
Pe Person
R Ramp
S Support surface for film cover F
V Device for dry water-jet massage
W Tub
Z Toothed racks arranged transversely to the longitudinal
direction of the tub
ZR Gears coaxial and in engagement with the spline shafts 5, 5′
1 Nozzle cart
2 Motor
3 Drive
4, 4′, 4″ Wheels for moving the nozzle cart 1 on rails on the tub bottom
5, 5′ Spline shaft
6, 6′ Spline shaft
10 Bottom plate
12, 12′ Vertical left/right side plates
14, 14′, 14″ Pivot axes in the transverse direction of the tub W
16, 16′ Tilting plates
16a Horizontal connecting support
17, 17′ Outer rolling wheels on the tilting plates 16, 16′
18, 18′ Additional outer parallel rails having a rising ramp
100 Convex formation on the top of the film/concave cavities on the bottom of the film F

1. A device (V) for dry water-jet massage, comprising
a tub (W), which is filled with massage water and runs from a head end to a foot end in the longitudinal direction and from a left side to a right side in the transverse direction, having a film material (F) as a cover closing the tub (W) water-tight on the top side, which film material is simultaneously used as a lying surface for a person (Pe) to be treated and allows the transmission of pressure pulses;
a nozzle cart (1), which can be moved in the longitudinal direction of the tub (W) and bears at least two nozzles (D, D′, D″), which nozzles (D, D′, D″) can be fed via a flexible hose connection with massage water from the tub (W) by means of a pump (P) in order to eject one water jet per nozzle against the bottom side of the film material (F);
a first drive (3) for forward and backward movement of the nozzle cart (1) in the longitudinal direction of the tub (W), the at least two nozzles (D, D′) moving forward and backward in the longitudinal direction of the tub (W) with the movement of the nozzle cart (1); and
a second drive (5, ZR, Z), which moves the nozzles (D, D′) in the transverse direction of the tub (W);
characterized in
that the film material (F) has one or more cavity/cavities on the bottom side of the film, which run in the transverse direction, being directed at the person (PE) lying on the film material (F), and shaping the film (F) into one or more elevated portions (100), which are convex on the top side of the film.

2. The device according to claim 1, wherein means for displacing the nozzles out of the plane of the tub are provided, which allow directing the ejected water jet against the cavity/cavities on the bottom side of the film and in particular against a surface inclined relative to the plane of the film (F) of the cavity/cavities on the bottom side of the film.

3. The device according to claim 2, wherein a part of the nozzle cart carrying the nozzles is pivotable relative to the nozzle cart about an axis in the direction of the film (F), and that the ejected water jet assumes an angle to the normal of the film (F) by pivoting.

4. The device according to claim 3, wherein the pivoting movement of the part carrying the nozzles is achieved by a ramp arranged in the tub (W), and wherein the forward and backward movement generated by the first drive displaces the part with respect to the ramp (R) and thus pivots upward about a horizontal axis.

5. The device according to any of the preceding claims, wherein the nozzles are each arranged in a nozzle holder (DH), and that the nozzle holder (DH) is connected to a toothed rack (Z) which, as part of the second drive, allows the individual displacement of the nozzle holder (DH) in the transverse direction of the tub by means of a gear of the drive.

6. The device according to claim 5, wherein the nozzle holder (DH) can be pivoted relative to the toothed rack (Z), and wherein the toothed rack (Z) is movably connected to two axes (14; 14′) of the nozzle cart (1).

7. The device according to claim 5 or 6, wherein the nozzle holder (DH) is connected to a rigid axle (14′) of the nozzle cart (1) such that it can be axially displaced and pivoted.

8. The device according to any of the preceding claims, wherein the nozzle cart (1) a can be moved on wheels (4, 4′, 4″) in the longitudinal direction of the tub (W) on two rails that are fixed on the bottom (B) of the tub (W), and wherein the nozzle cart (1) can be operated with the first drive (3) which acts on the bottom side of the nozzle cart (1) by means of a motor (2″) which is mounted inside the tub (W) and can be operated from outside the tub (W) and can be operated for the forward and backward movement of the nozzle cart (1) on the wheels (4, 4′, 4″) in the longitudinal direction of the tub (W).

9. The device according to any of the preceding claims, wherein the nozzle cart (1) comprises, parallel to the tub bottom (B), a horizontal base plate (10) which can be moved in the longitudinal direction of the tub on the wheels (4, 4′, 4″) and has a vertical side plate (12, 12′) fixed to the bottom plate (10) in each case on the left and on the right, wherein a first pivot axis (14) running in the transverse direction of the tub (W) and optionally a second pivot axis (14′) running in the transverse direction of the tub (W) and being offset from the first pivot axis (14) and being able to serve for guiding purposes rigidly connects the vertical side plates (12, 12′) together.

10. The device according to any of the preceding claims, wherein a vertically extending tilting plate (16, 16′) is mounted on each of the outer sides of the side plates (12, 12′), so as to be pivotable about the first pivot axis (14) running in the transverse direction of the tub (W) and a rigid axis (14″) running in the transverse direction of the tub (W) rigidly connects the tilting plates (16, 16′) to one another, wherein each of the tilting plates (16, 16′) has an rolling wheel (17, 17′) on the outside (in the transverse direction) at the end lying opposite the tilting plate stop in each case with one wheel axis parallel to the first and second pivot axes (14, 14′).

11. The device according to any of the preceding claims, wherein the movement of the at least two nozzles (D, D′) running in the transverse direction of the tub can be effected by means of two spline shafts (5, 5′) running parallel to the longitudinal axis of the device (V) in each case through a bushing (LB) on the bottom side of the nozzle cart (1) and being in engagement with respectively a gear (ZR) with a gear axis arranged on the bottom side of the nozzle cart bottom being concentric in each case with one of the spline shafts, and the spline shafts (5, 5′) are mounted on a head side in a bearing (L, LC) lying inside the tub so as to be rotatable about their own axis and are controlled on a foot side by a drive motor (2, 2′) lying outside the tub (W) to perform a rotating back-and-forth movement around each spline shaft longitudinal axis, wherein the gears (ZR) that are each engaged with respectively a spline shaft are in turn engaged with toothed racks (Z) that are arranged parallel to the pivot axes (14, 14′, 14″) on the lower nozzle holders (DH) and cause an independent movement of the nozzles in the transverse direction of the tub along the pivot axes (14, 14′, 14″), without the spline shafts (5, 5′) having load-bearing function, in particular nozzle cart (1)-bearing function.

12. The device according to any of the preceding claims, wherein at least one of the nozzles (D, D′, D″) is furthermore able to direct its ejected water jet on the bottom side of the film material (F) onto the interior of the one or more cavities (100) on the bottom side of the film which form convex elevated portions (100) on the top side of the film material (F).

13. The device (V) for dry water-jet massage according to any of the preceding claims, wherein the film material (F) which allows a transmission of pressure pulse as the top cover of the device (V) is also capable of a heat transmission; preferably wherein the film (F) serving as the top cover of the tub (W) comprises a natural rubber film, optionally with a carrier layer made of chlorosulfonated polyethylene (CSM).

14. The device (V) for dry water-jet massage according to any of the preceding claims, wherein the one or more cavity/cavities of the film material (F) on the bottom side of the film, which run in the transverse direction, being directed at the person (Pe) lying on the film material (F) and shaping the film (F) into one or more elevated portions (100), which are convex on the top side of the film, have a depth, calculated from the inner surface of the film material (F), in the range from 1 mm to 200 mm, preferably in the range from 1 mm to 100 mm.

15. The device (V) for dry water-jet massage according to one or more of the preceding claims, which is able to transfer the independently controllable rotation of the two spline shafts (5, 5′) mounted at the head end and foot end of the tub (W) and in each case extending through a bushing (LB) under the base plate of the nozzle cart (1) about their respective axis of rotation running in the longitudinal direction of the tub (W) via the two gear wheels (ZR) which are in engagement with the two spline shafts (5, 5′) in each case to one toothed rack (Z) which is movable in the transverse direction of the tub and is in each case in engagement with one gear wheel (ZR), which rack in turn is able to move in each case a nozzle holder (DH) with a nozzle (D, D′) directed against the bottom side of the film material (F) on the pivot axes (14, 14′, 14″) at right angles to the longitudinal direction of the tub (W) to the right or left side of the tub (W) independently of the other nozzle, wherein the combination of the movements of the nozzles (D, D′, D″) on the nozzle cart (1) in the longitudinal direction and in the transverse direction of the tub (W) allows the formation of any water-jet massage pattern on the bottom side of the film material (F).

16. The device (V) for dry water-jet massage according to one or more of the preceding claims, comprising at least one nozzle (D′″) which is not arranged on the nozzle cart (1) and is able to direct its ejected water jet onto the interior of at least one of the one or more cavities on the bottom side of the film, which run in the transverse direction, being directed at the person (Pe) lying on the film material (F), and shaping the film (F) into one or more elevated portions (100), which are convex on the top side of the film.

17. The device (V) for dry water-jet massage according to one or more of the preceding claims, comprising at least one nozzle (D″) on the nozzle cart (1) which is able to direct each ejected water jet onto the interior of at least one of the one or more cavities on the bottom side of the film, which run in the transverse direction, being directed at the person (Pe) lying on the film material (F), and shaping the film (F) into one or more elevated portions (100), which are convex on the top side of the film.

18. The device (V) for dry water-jet massage according to one or more of the preceding claims, comprising the at least two nozzles (D, D′) on the nozzle cart (1) which are able to direct each ejected water jet either on the bottom side of the film material (F) or onto the interior of at least one of the one or more cavities on the bottom side of the film, which run in the transverse direction, being directed at the person (Pe) lying on the film material (F), and shaping the film (F) into one or more elevated portions (100), which are convex on the top side of the film.

19. The device (V) for dry water-jet massage according to claim 18, wherein the at least two nozzles (D, D′) on the nozzle cart (1) are able, when moving the nozzle cart (1) in a plane parallel to the bottom of the tub (1), spanned by the long sides and the transverse sides of the tub (W), to direct each ejected water jet substantially perpendicular to the bottom side of the film material (F).

20. The device (V) for dry water-jet massage according to one or more of the preceding claims, additionally comprising in each case one additional rail (18, 18′) on the respective left and right outer sides of the two rails fixed on the bottom (B) of the tub (W) in the longitudinal direction of the tub (W) for moving the nozzle cart (1) for the run of the rolling wheels (17, 17′) attached on the two tilting plates (16, 16′) parallel to the run of the wheels (4, 4′, 4″) on the bottom of the tub (W) when moving the nozzle cart (1) in the longitudinal direction of the tub (W), wherein the rails (18, 18′) run at a plurality of locations, preferably in the region of the head end and/or in the region of the foot end of the tub (W), on rising ramps toward the tub end, which are able to pivot the ends of the tilting plates (16, 16′) at the end of the nozzle cart about the first pivot axis (14) away from the bottom (B) of the tub (W) in the direction of the film (F), whereby the angle of each massage water jet of each nozzle (D, D′) rigidly connected to the tilting plate (16, 16′) with the bottom side of the film changes with increasing pivoting of the tilting plates (16, 16′) from substantially 90° to acute angles, preferably up to an angle of <10°, based on the bottom side of the mat.

21. The device (V) for dry water-jet massage according to claim 18 and claim 20, wherein the at least two nozzles (D, D′) on the nozzle cart (1) are able to direct each ejected water jet onto the interior of at least one of the one or more cavities on the bottom side of the film, which run in the transverse direction, being directed at the person (Pe) lying on the film material (F), and shaping the film (F) into one or more elevated portions (100), which are convex on the top side of the film.

22. A dry water-jet massage method, in which the body of a person to be treated, which is arranged on a film material (F) which allows a transmission of pressure pulse and which is designed as a top cover of a device (V) according to any of claims 1 to 21, is exposed to a water jet pressure pulse ejected through at least one nozzle (D, D′, D″, D′″) onto the bottom side of the film material (F) and optionally into the interior of at least one of the one or more transversely extending cavity/cavities on the bottom side of the film directed at the person (Pe) lying on the film material (F) and shaping the film (F) to one or more convex elevated portion(s) (100) on the top side of the film (F) with translational movement of at least one of the nozzles (D, D′, D″, D′″) delivering the pulse for a certain time in the longitudinal direction and transverse direction of the tub, which has a massage effect on the body.

23. Use of the device according to any of claims 1 to 21 for dry body massage by means of water jets, preferably for massage for relieving cramps, tension (for example muscle tension), tenseness (for example stress-related muscular tenseness), for the reduction of stress (for example for the elimination of stress-related or postural hardening of the trapezius muscle), for the alleviation or elimination of pain (for example in the case of sports injuries or for the alleviation or elimination of back or joint pain, muscular imbalances, muscular fatigue, muscle tone disorders), for the improvement of blood circulation (for example for the elimination of (chronic) venous congestion syndrome or circulatory and metabolic disorders), for the treatment of cervical migraines, for the treatment of fibromyalgia, for the elimination of reversible functional disorders of the spine and for the combat of the cervical and thoracic spine syndrome and the so-called lumbar syndrome.

24. Use of the device according to any of claims 1 to 21 for dry body massage by means of water jets to increase metabolic performance, to loosen subcutaneous cell tissue, for venous and lymphatic decongestion, to loosen scar tissue, to activate and dampen the vegetative nervous system with beneficial effects on the internal organs.

25. A method for operating a device (V) for dry water-jet massage according to any of claims 1 to 21, comprising the steps of
directing the water jet ejected by a nozzle (D; D′) against the film material (F) and/or one of the cavity/cavities (100) on the bottom side of the film with simultaneous pivoting of a nozzle holder (DH) carrying the nozzle (D; D′) about an axis (14′) running perpendicular to the direction of displacement of the nozzle cart, whereby the distance between the nozzle (D; D′) and the film is reduced and/or the parts of the cavity/cavities (100) on the bottom side of the film are charged with the water jet.
